(19) United States
(12) Patent Application Publication
(10) Pub. No.: US 2013/0208038 A1
(43) Pub. Date: Aug. 15, 2013

(54) LIQUID SUPPLYING MECHANISM, COMPUTER READABLE MEDIUM AND IMAGE FORMING APPARATUS

(71) Applicants: FUJI XEROX CO., LTD., (US); FUJIFILM CORPORATION, (US)

(72) Inventors: Jun ISOZAKI, Kanagawa (JP); Masaki KATAOKA, Kanagawa (JP); Koji FURUKAWA, Kanagawa (JP)

(73) Assignees: FUJIFILM CORPORATION, Tokyo (JP); FUJI XEROX CO., LTD., Tokyo (JP)

(21) Appl. No.: 13/711,744

(22) Filed: Dec. 12, 2012

(30) Foreign Application Priority Data
Feb. 15, 2012 (JP) 2012-030996

(51) Int. Cl. B41J 2/175

(52) U.S. Cl. CPC B41J 2/175
USPC 347/14

(57) ABSTRACT

A liquid supplying mechanism includes a control unit that controls a first pressure adjusting unit and a second pressure adjusting unit by control parameters each having a given initial value on the basis of a supply pressure detected by a first detecting unit and a discharge pressure detected by a second detecting unit, respectively, so that the supply pressure is higher than the discharge pressure while a back pressure at a nozzle surface is maintained at a given value, and when deviations of the detected supply pressure and the detected discharge pressure with respect to the corresponding target pressure value exceed a given reference value, controls each of the first pressure adjusting unit and the second pressure adjusting unit by changing the control parameters from the initial values.

### CROSS-REFERENCE TO RELATED APPLICATIONS

This application is based on and claims priority under 35 USC 119 from Japanese Patent Application No. 2012-030996 filed on Feb. 15, 2012.

### BACKGROUND

### Technical Field

The present invention relates to a liquid supplying mechanism, a computer readable medium and an image forming apparatus.

### SUMMARY

According to an aspect of the invention, a liquid supplying mechanism comprises: a storage unit that stores a liquid; a supply line that supply a liquid from the storage unit to a jetting unit that discharges the liquid from a nozzle surface thereof; a discharge line that discharges the liquid from the jetting unit to the storage unit; a first detecting unit that detects a supply pressure of the liquid within the supply line; a second detecting unit that detects a discharge pressure of the liquid within the discharge line; a first pressure adjusting unit that adjusts the supply pressure of the liquid within the supply line; a second pressure adjusting unit that adjusts the discharge pressure of the liquid within the discharge line; and a control unit that controls the first pressure adjusting unit and the second pressure adjusting unit by control parameters each having a given initial value on the basis of the supply pressure detected by the first detecting unit and the discharge pressure detected by the second detecting unit, respectively, so that the supply pressure is higher than the discharge pressure while a back pressure at the nozzle surface is maintained at a given value, and when deviations of the detected supply pressure and the detected discharge pressure with respect to the corresponding target pressure value exceed a given reference value, controls each of the first pressure adjusting unit and the second pressure adjusting unit by changing the control parameters from the initial values.

### BRIEF DESCRIPTION OF THE DRAWINGS

Exemplary embodiment(s) of the present invention will be described in detail based on the following figures, wherein:

FIG. 1 is a schematic view illustrating a configuration of an inkjet recording apparatus;

FIG. 2 is a schematic view illustrating a configuration of an ink supplying mechanism;

FIG. 3 is a block diagram of a control unit that controls the operation of an inkjet head;

FIG. 4 is a view illustrating a first control flow;

FIG. 5 is a view illustrating a second control flow;

FIG. 6 is a view illustrating a third control flow;

FIG. 7 is a view illustrating a fourth control flow;

FIG. 8 is a view illustrating a flow of a first control parameter control operation;

FIG. 9 is a view illustrating a flow of a second control parameter control operation;

FIG. 10 is a view illustrating a flow of an operation for checking whether a first printing is available or not;

FIG. 11 is a view illustrating a flow of an operation for checking whether a second printing is available or not;

FIG. 12 is a view illustrating the pressure change in a case where the supply pump and the discharge pump are controlled using the first control flow;

FIG. 13 is a view illustrating the pressure change in a case where the supply pump and the discharge pump are controlled using the first control flow;

FIG. 14 is a view illustrating the pressure change in the first control parameter check operation;

FIG. 15 is a view illustrating the pressure change in the first control parameter check operation;

FIG. 16 is a view illustrating the pressure change in the operation for checking whether the first printing is available or not; and

FIG. 17 is a view illustrating the pressure change in the operation for checking whether the first printing is available or not.

### DETAILED DESCRIPTION

Hereinafter, exemplary embodiments of the present invention will be described with respect to the accompanying drawings.

In the present exemplary embodiments, an inkjet recording apparatus in which ink droplets are discharged to record an image onto a recording medium will be described as an example of an image forming apparatus.

However, the image forming apparatus is not limited to the inkjet recording apparatus. Examples of the image forming apparatus may include, for example, a color filter manufacturing apparatus in which, for example, inks are discharged onto, for example, a film or a glass to manufacture a color filter, an apparatus in which an organic EL solution is discharged onto a substrate to form an EL display panel, an apparatus in which a solder in a welded state is discharged onto a substrate to form a bump for mounting a part, an apparatus in which a liquid including a metal is discharged to form a wiring pattern, and various film forming apparatuses in which liquid droplets are discharged to form a film. Further, an apparatus may be included as long as an image is formed by a liquid.

### Configuration of Inkjet Recording Apparatus

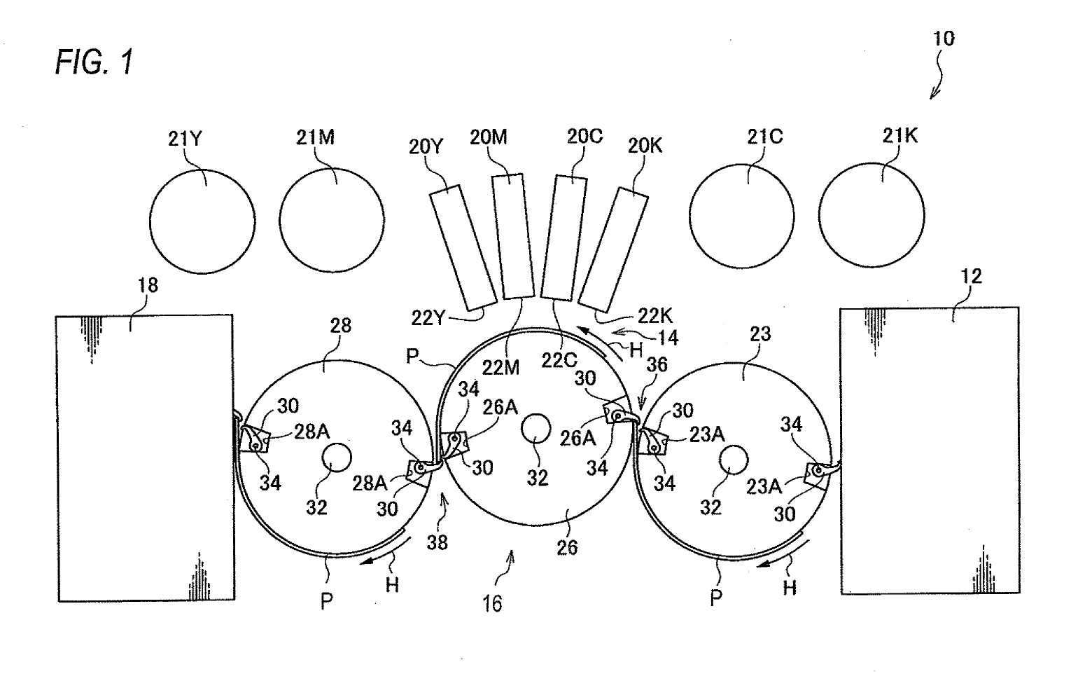

First, the configuration of an inkjet recording apparatus will be described. FIG. 1 is a schematic view illustrating a configuration of an inkjet recording apparatus according to the present exemplary embodiment.

As illustrated in FIG. 1, an inkjet recording apparatus 10 includes: a recording medium receiving unit 12 in which a recording medium P such as, for example, a paper is received; an image recording unit (an example of an image forming unit) 14 that records an image onto the recording medium P; a transporting unit 16 that transports the recording medium P from the recording medium receiving unit 12 to the image recording unit 14; and a recording medium discharging unit 18 that discharges the recording medium P on which an image is recorded by the image recording unit 14.

The image recording unit 14 is an example of a jetting unit that discharges a liquid, and includes inkjet recording heads 20Y, 20M, 20C and 20K (hereinafter, referred to as “20Y to 20K”) that discharge ink droplets to record an image onto the recording medium.

Further, the inkjet recording heads 20Y to 20K include nozzle surfaces 22Y to 22K, respectively. Each of the nozzle surfaces has a nozzle (not illustrated). The nozzle surfaces 22Y to 22K include a recordable area equal to or wider than a maximum width of the recording medium P on which an image recording is expected in the inkjet recording apparatus 10. Meanwhile, the width of the recording medium P is the length in a direction perpendicular to the transporting direction of the recording medium P (a depth direction toward the inner side of the paper in FIG. 1).

In addition, the inkjet recording heads 20Y to 20K are arranged in parallel from downstream in the transporting direction of the recording medium P in the order of colors of a yellow Y, a magenta M, a cyan C and a black K, and are configured so that ink droplets, which respectively correspond the colors, are discharged from the plural nozzles to record an image. In the inkjet recording heads 20Y to 20K, the configuration that discharges the ink droplets may use other configuration such as, for example, a thermal type.

The inkjet recording apparatus 10 is provided with ink tanks 21Y, 21M, 21C, 21K (hereinafter, referred to as “21Y to 21K”), as an example of a storage unit that stores a liquid, in which each of the ink tanks 21Y to 21K stores one of the color inks. The inks are supplied from the ink tanks 21Y to 21K to the inkjet recording heads 20Y to 20K, respectively. As the inks supplied to the inkjet recording heads 20Y to 20K, various inks such as, for example, an aqueous ink, an oil ink, a solvent-based ink may be used.

The transporting unit 16 includes: an extraction drum 23 that draws out a recording medium P in the recording medium receiving unit 12 one by one; a transport drum 26 as a face body that transports the recording medium P to the inkjet recording heads 20Y to 20K of the image recording unit 14 in such a manner that the recording surface (surface) of the recording medium P is opposed to the inkjet recording heads 20Y to 20K; and a delivery drum 28 that delivers the recording medium P recorded with an image to the recording medium discharging unit 18. The extraction drum 23, the transport drum 26 and the delivery drum 28 are configured so that the recording medium P is held the vicinity of the peripheral surface thereof by electrostatic adsorption means or non-electrostatic adsorption means, for example, suction or adhesion.

Further, each of the extraction drum 23, the transport drum 26 and the delivery drum 28 is provided with, for example, two sets of grippers 30 as holding means for holding the recording medium P with the end of the recording medium P of the downstream side in the transport direction, and the three drums 23, 26, 28 are configured so that the recording medium P (in this example, up to two sheets) may be held by the grippers 30 in the peripheral surfaces. The grippers 30 are provided in concave portions 23A, 26A, 28A which are formed by two on the peripheral surface of each of the drums 23, 26, 28.

Specifically, at a predetermined position within each of the concave portions 23A, 26A, 28A of each of the drums 23, 26, 28, a rotation axis 34 is held along a rotation axis 32 of each of the drums 23, 26, 28, a plurality of grippers 30 are fixed to the rotation axis 34 with an interval in the axial direction. Therefore, as the rotation axis 34 is rotated in both of forward and reverse directions by an actuator (not illustrated), the grippers 30 may be rotated in the both of forward and reverse directions along the circumference direction of each of the drums 23, 26, 28 to hold/drop the recording medium P with the end of the recording medium P in the downstream side in the transport direction.

That is, the grippers 30 are rotated while the front end of each of the drums 23, 26, 28 protrudes slightly, and thus, the recording medium P may be transferred from the grippers 30 of the extraction drum 23 to the grippers 30 of the transport drum 26 in a transfer position 36 in which the peripheral surface of the extraction drum 23 faces with the peripheral surface of the transport drum 26, and the recording medium P may be transferred from the grippers 30 of the transport drum 26 to the grippers 30 of the delivery drum 28 in a transfer position 38 in which the peripheral surface of the transport drum 26 faces with the peripheral surface of the delivery drum 28.

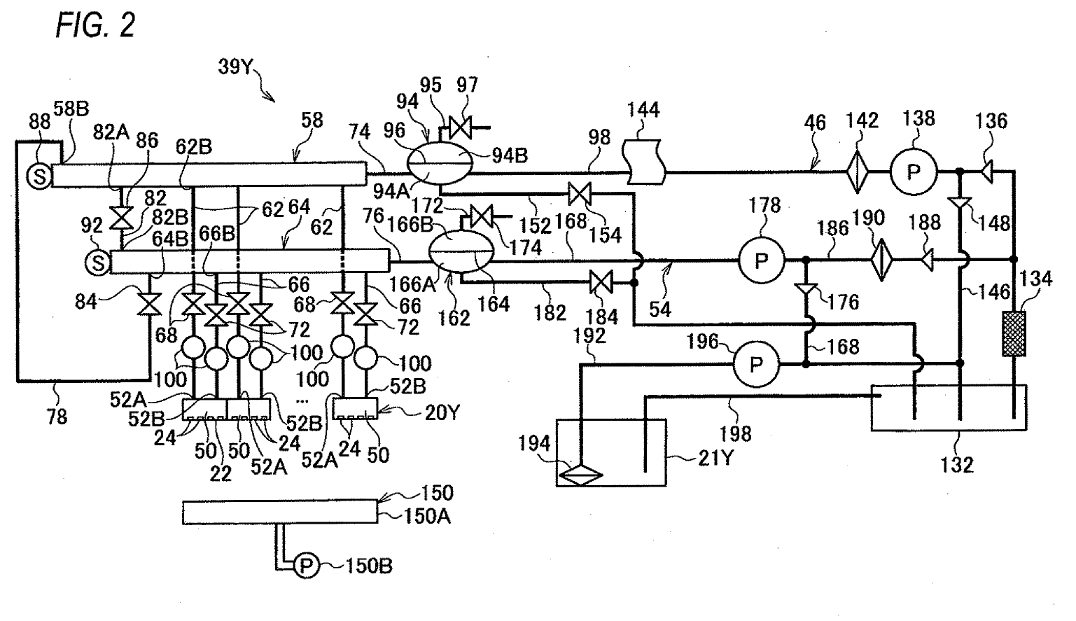

Further, the inkjet recording apparatus 10 includes a maintenance unit 150 that maintains the inkjet recording heads 20Y to 20K (see, e.g., FIG. 2). The maintenance unit 150 includes a cap 150A that covers the nozzle surfaces of the inkjet recording heads 20Y to 20K (a jetting module 50 as described below), a support member that receives a droplet which is preliminary discharged (idle discharged), a cleaning member that cleans the nozzle surface, and a suction device 150B that sucks the ink within the nozzle. The maintenance unit 150 moves into a facing position which faces with the inkjet recording heads 20Y to 20K to perform various maintenances.

As illustrated in FIG. 2, the inkjet recording head 20Y includes a plurality of jetting modules 50 as an example of the jetting unit that discharges an ink from the nozzle surface 22. A supplying port 52A capable of supplying an ink from outside to inside of the jetting module 50 and a discharging port 52B capable of discharging the ink supplied through the supplying port 52A from inside to outside of the jetting module 50 are provided in each of the jetting modules 50.

Next, an image recording operation of the inkjet recording apparatus 10 (an example of the image forming operation) will be described.

The recording medium P drawn out and held by the grippers 30 of the extraction drum 23 one by one from the recording medium receiving unit 12 is transported while being absorbed on the peripheral surface of the extraction drum 23 to be transferred from the grippers 30 of the extraction drum 23 to the grippers 30 of the transport drum 26 in the transfer position 36.

The recording medium P held by the grippers 30 of the transport drum 26 is transported to the image recording position of the inkjet recording heads 20Y to 20K while being absorbed on the transport drum 26, and an image is recorded on the recording surface thereof by the ink droplets discharged from the inkjet recording heads 20Y to 20K.

The recording medium P in which the image is recorded on the recording surface thereof is transferred to the grippers 30 of the delivery drum 28 from the grippers 30 of the transport drum 26 in the transfer position 38. Then, the recording medium P held by the grippers 30 of the delivery drum 28 is transported while being absorbed on the delivery drum 28 to be discharged to the recording medium discharging unit 18. As described above, a series of image recording operations are executed.

### Configuration of Ink Supplying Mechanism

Next, the configuration of an ink supplying mechanism will be described. The ink supplying mechanisms which correspond to the inkjet recording heads 20Y to 20K, respectively, are the same as each other, and thus, hereinafter an ink supplying mechanism 39Y corresponding to an inkjet recording head 20Y will be described as an example. FIG. 2 is a schematic view illustrates an ink supplying mechanism 39Y that supplies ink to the inkjet recording head 20Y.

As illustrated in FIG. 2, one end of an individual supply line 62 capable of flowing ink is connected to each of the supplying ports 52A of the plurality of jetting modules 50. The other ends of a plurality of individual supply lines 62 are connected to different positions of a supply manifold 58 capable of flowing ink, respectively.

In each of the discharging ports 52B of the plurality of jetting modules 50 are connected to one ends of the individual discharge lines 66 capable of flowing ink, respectively. The other ends of the plurality of individual discharge lines 66 are connected to different positions of a discharge manifold 64 capable of flowing ink, respectively.

In the individual supply line 62, a supply valve 68 as a first opening/closing mechanism capable of opening/closing the individual supply line 62 is provided. When the supply valve 68 is opened, the individual supply line 62 may flow ink, but when the supply valve 68 is switched into a closed state, the ink flow of the individual supply line 62 is blocked.

In the individual supply line 62, a buffer 100 that buffers the pressure fluctuation generated in the ink within the individual supply line 62 is provided between the supply valve 68 and the jetting module 50.

In the individual discharge line 66, a discharge valve 72 as a second opening/closing mechanism capable of opening/closing the individual discharge line 66 is provided. When the discharge valve 72 is in an opened state, the individual discharge line 66 may flow an ink, but when the discharge valve 72 is switched into the closed state, the ink flow of the individual discharge line 66 is blocked.

In the individual discharge line 66, a buffer 100 that buffers the pressure fluctuation generated in the ink within the individual discharge line 66 is provided between the discharge valve 72 and the jetting module 50.

As illustrated in FIG. 2, one end of a supply pipe 74 (left-side end in FIG. 2) is attached to the one end of the supply manifold 58 (right-side end in FIG. 2) in the longitudinal direction, and one end of a discharge pipe 76 (left-side end in FIG. 2) is attached to the one end of the discharge manifold 64 (right-side end in FIG. 2) in the longitudinal direction.

Further, in the other end of the supply manifold 58 (left-side end in FIG. 2), a supply pressure sensor 88 is provided as an example of a first detecting unit that detects the supply pressure of the ink within the supply manifold 58. The supply pressure sensor 88 is configured to detect the supply pressure based on, for example, the nozzle surface 22 of the jetting module 50. In the other end of the discharge manifold 64 (left-side end in FIG. 2), a discharge pressure sensor 92 is provided as an example of a second detecting unit that detects the discharge pressure of the ink within the discharge manifold 64. The discharge pressure sensor 92 is configured to detect the discharge pressure based on, for example, the nozzle surface 22 of the jetting module 50.

Further, the other end of the supply pipe 74 connected to the supply manifold 58 is connected to a supply sub tank 94 that temporarily stores the ink and alleviates the pressure fluctuation generated in the ink at the same time. The supply sub tank 94 is configured as a two-chamber structure where a membrane member 96 having an elastic force partitions the inside thereof. The lower side thereof is a sub tank chamber for an ink 94A and the upper side thereof is an air chamber 94B. One end of a supply main pipe 98 to draw in the ink from a buffer tank 132 which is connected to the ink tank 21Y is connected to the sub tank chamber for an ink 94A. The other end of the supply main pipe 98 is connected to the buffer tank 132. An opened pipe 95 is connected to the air chamber 94B, and the opened pipe 95 is provided with a supply air valve 97. The supply sub tank 94 is configured to alleviate the pressure fluctuation of the ink generated in the sub tank chamber for an ink 94A by the damper effect of the air chamber 94B partitioned using the membrane member 96 in the closed state of the supply air valve 97.

The supply main pipe 98 is provided with a degassing module 134, a one-way valve 136, a supply pump 138 as an example of a first pressure adjusting unit that adjusts the supply pressure within the supply main pipe 98 based on the supply pressure detected by the supply pressure sensor 88, a supply filter, and an ink temperature controller 144 in this order from the buffer tank 132 to the supply sub tank 94. Therefore, during the supply of the ink stored in the buffer tank 132 into the supply sub tank 94 by the driving force of the supply pump 138, bubbles are removed from the ink and at the same time the temperature of the ink is managed. Meanwhile, one end portion of the branch pipe 146 is connected to an inlet of the supply pump 138 apart from the supply main pipe 98 and the other end portion of the branch pipe 146 is connected to the buffer tank 132 through the one-way valve 148.

The supply pump 138 is configured as a pump (for example, a tube pump) capable of supplying an ink into both normal and reverse directions. Therefore, the supply pump 138 supplies the ink in the normal direction, and thus, a portion in the supply main pipe 98 at the downstream side of the supply pump 138 is pressurized. And, the supply pump 138 supplies the ink in the reverse direction, and thus, the portion in the supply main pipe 98 at the downstream side of the supply pump 138 is depressurized.

One end of a drain pipe 152 is connected to the sub tank chamber for an ink 94A, the other end of the drain pipe 152 is connected to the buffer tank 132. And, the drain pipe 152 is provided with a supply drain valve 154.

Since the supply sub tank 94 is configured as a structure in which ink is circulated to trap the bubble within the flow line, the supply drain valve 154 is opened, the bubble within the supply sub tank 94 is delivered to the buffer tank 132 by the driving force of the supply pump 138, and the bubbles are discharged from the buffer tank 132 which is opened toward the atmosphere.

Next, the other end of the discharge pipe 76 connected to the discharge manifold 64 is connected to a discharge sub tank 162 that temporarily stores the ink and alleviates the pressure fluctuation generated in the ink at the same time. The discharge sub tank 162 is configured as a two-chamber structure where a membrane member 164 having an elastic force partitions the inside thereof. The lower side thereof is a sub tank chamber for an ink 166A and the upper side thereof is an air chamber 166B. One end of a discharge main pipe 168 to draw in the ink from the buffer tank 132 is connected to the sub tank chamber for an ink 166A. The other end of the discharge main pipe 168 is connected to the buffer tank 132. An opened pipe 172 is connected to the air chamber 166B, and the opened pipe 172 is provided with a discharge air valve 174. The discharge sub tank 162 is configured to alleviate the pressure fluctuation of the ink generated in the sub tank chamber for an ink 166A by the damper effect of the air chamber 166B partitioned using the membrane member 164 in the closed state of the discharge air valve 174.

The discharge main pipe 168 is provided with a one-way valve 176, and a discharge pump 178 as an example of a second pressure adjusting unit that adjusts the discharge pressure within the discharge main pipe 168 based on the discharge pressure detected by the discharge pressure sensor 92 in this order toward the discharge sub tank 162. Therefore, the driving force of the discharge pump 178 discharges the ink within the discharge sub tank 162 to the buffer tank 132. Further, one end of a drain pipe 182 is connected to the sub tank chamber for an ink 166A, the other end of the drain pipe 182 is connected to the drain pipe 152 through the discharge drain valve 184.

The discharge pump 178 is also configured as a pump (for example, a tube pump) capable of supplying an ink into both normal and reverse directions. Therefore, the discharge pump 178 supplies the ink in the normal direction, and thus, a portion in the discharge main pipe 168 at the upstream side of the discharge pump 178 is depressurized. And, the discharge pump 178 supplies the ink in the reverse direction, and thus, the portion in the discharge main pipe 168 at the upstream side of the discharge pump 178 is pressurized.

Since the discharge sub tank 162 is configured as a structure in which ink is circulated to trap the bubbles within the flow line, the discharge drain valve 184 is opened, the bubbles within the discharge sub tank 162 are delivered to the buffer tank 132 by the driving force of the reverse rotation of the discharge pump 178, and the bubbles are discharged from the buffer tank 132 which is opened toward the atmosphere.

Meanwhile, a pressurization purge pipe 186 is provided between the inlet side of the discharge pump 178 and the outlet side of the degassing module 134 in the supply main pipe 98. A one-way valve 188 and a discharge filter 190 are provided sequentially from the degassing module 134 to the discharge pump 178 in the pressurization purge pipe 186. That is, when ink is discharged with one rush by pressurizing the inside of the jetting module 50 to remove the air bubbles, the degassed ink is supplied from the buffer tank 132 to the discharge manifold 64 by reversing a driving direction of the discharge pump 178 against a normal driving direction in addition to the driving of the supply pump 138.

The buffer tank 132 is configured to flow the ink with the ink tank 21K (main tank) by a supplement pipe 192 having a supplement pump 196. And, the amount of ink required to circulate ink is stored in the buffer tank 132, and the ink is refilled from the ink tank 21Y as ink is consumed. A filter 194 is attached on one end of the supplement pipe 192 (within the ink tank 21Y). Meanwhile, an overflow pipe 198 is installed between the buffer tank 132 and the ink tank 21Y, such that the ink is returned to the ink tank 21Y when the ink is over-refilled.

In the ink supplying mechanism 39Y, one end of a first flow line 78 capable of flowing ink is connected to the downstream in the ink flowing direction when viewed from a connection portion 62B of the individual supply line 62 which is connected in the most downstream side (left side in FIG. 2) in the ink flow direction with respect the supply manifold 58. The other end of the first flow line 78 is connected to the upstream side in the ink flow direction of the discharge manifold 64 when viewed from a connection portion 66B of the individual discharge line 66 connected at the most upstream in the ink flow direction (left side in FIG. 2). Therefore, the first flow line 78 is configured to flow the ink in parallel to each jetting module 50, between the supply manifold 58 and the discharge manifold 64. The first flow line 78 is provided with a first flow valve 84 capable of opening/closing the first flow line 78.

One end of a second flow line 82 capable of flowing ink is connected to the supply manifold 58 in the downstream in the flow direction (left side in FIG. 2) than the connection portion 62B of the individual supply line 62 and in the upstream in the flow direction (right side in FIG. 2) than a connection portion 58B of the first flow line 78 to the supply manifold 58. The other end of the second flow line 82 is connected to the discharge manifold 64 in the upstream in the ink flow direction (left side in FIG. 2) than a connection portion 64B of the first flow line 78 to the discharge manifold 64. Therefore, the second flow line 82 is configured to flow the ink in parallel to each jetting module 50 and the first flow line 78, between the supply manifold 58 and the discharge manifold 64. The second flow line 82 is provided with a second flow valve 86 capable of opening/closing the second flow line 82.

Meanwhile, in the ink supplying mechanism 39Y, a common supply line 46 in which the ink in the buffer tank 132 (an example of a storage unit) is supplied to each of individual supply lines 62 is constituted by the supply manifold 58, the supply pipe 74, the supply sub tank 94 and the supply main pipe 98. A supply line where ink in the supply sub tank 94 is supplied to the jetting module 50 is constituted by the common supply line 46 and the individual supply lines 62.

The common supply line in the present exemplary embodiment is constituted by the supply manifold 58, the supply pipe 74, the supply sub tank 94, the supply main pipe 98, the buffer tank 132 and the supplement pipe 192, with the ink tank 21Y (an example of a storage unit) as a starting point.

Moreover, in the ink supplying mechanism 39Y, a common discharge line 54 in which the ink is discharged from each of individual discharge lines 66 to the buffer tank 132 (an example of a storage unit) is constituted by the discharge manifold 64, the discharge pipe 76, the discharge sub tank 162 and the discharge main pipe 168. A discharge line where ink is discharged from the jetting module 50 to the discharge sub tank 162 is constituted by the common discharge line 54 and the individual discharge lines 66.

The common discharge line in the present exemplary embodiment is constituted by the discharge manifold 64, the discharge pipe 76, the discharge sub tank 162, the discharge main pipe 168, the buffer tank 132 and the overflow pipe 198, with the ink tank 21Y (an example of a storage unit) as an end point.

In the ink supplying mechanism 39Y, a circulation line to circulate the ink is constituted by the buffer tank 132, the supply main pipe 98, the supply sub tank 94, the supply pipe 74, the supply manifold 58, the individual supply lines 62, the jetting module 50, the individual discharge lines 66, the discharge manifold 64, the discharge pipe 76, the discharge sub tank 162 and the discharge main pipe 168 in this order.

Meanwhile, in a normal operation state (a state where an image forming may be performed by the inkjet recording head 20Y based on an image forming instruction), the first flow line 78 is closed by the first flow valve 84 and at the same time the second flow line 82 is opened by the second flow valve 86, and thus, a portion of the ink is not via the individual supply lines 62, the jetting module 50, and the individual discharge lines 66, and circulates from the supply manifold 58 to the discharge manifold 64 through the second flow line 82. When a maintenance such as discharging bubble is performed, the first flow line 78 is opened by the first flow valve 84, and at the same time, the second flow line 82, the individual supply lines 62 and the individual discharge lines 66 are closed by the second flow valve 86, the supply valve 68 and the discharge valve 72, the ink circulates between the common supply line 46 and the common discharge line 54.

### Control Unit 200 of Inkjet Recording Apparatus 10

Next, a control unit 200 of the inkjet recording apparatus 10 will be described.

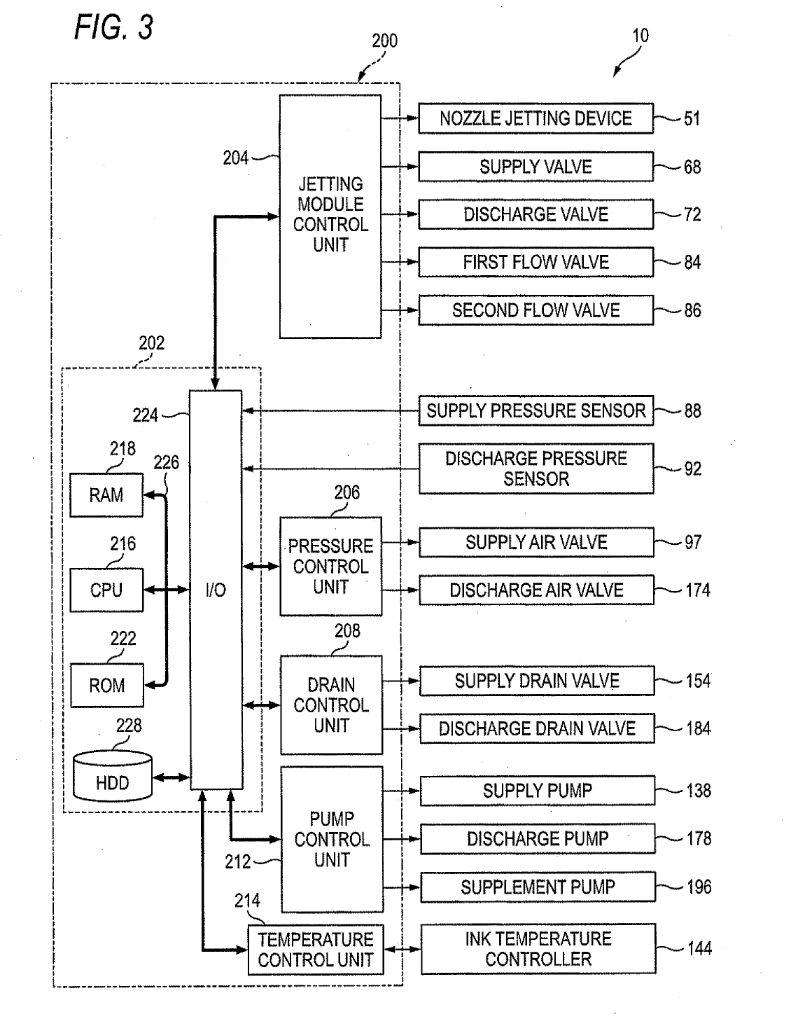

As illustrated in FIG. 3, the inkjet recording apparatus 10 includes the control unit 200 that controls the switch of a discharge operation to discharge the ink from the jetting module 50 based on the inputted signal and a recovery operation to discharge the ink from the jetting module 50 with a pressure higher than the discharge operation.

The control unit 200 is configured to include a micro-computer 202, a jetting module control unit 204, a pressure control unit 206, a drain control unit 208, a pump control unit 212 and a temperature control unit 214 which are connected to the micro-computer 202. The micro-computer 202 includes a CPU 216, a RAM 218, a ROM 222, an I/O unit 224, and a bus 226 such as, for example, a data bus or a control bus that connects the CPU 216, the RAM 218, the ROM 222, and the I/O unit 224.

A hard disk drive (HDD) 228 is connected to the I/O unit 224. The supply pressure sensor 88 and the discharge pressure sensor 92 are connected to the I/O unit 224. An image data when an image is formed by discharging ink from the nozzle 24 of the jetting module 50 is inputted into the I/O unit 224 from the outside. The image data may be a data in which an ink discharging position or a discharging amount is determined, or may be a compressed data such as, for example, a PEG. The CPU 216 reads out and executes a control program stored in the ROM 222.

The examples of the control program include a circulation control program that flows and circulates the ink in the buffer tank 132 from the supply manifold 58 to the discharge manifold 64, a discharge control program that discharges the ink droplet from the nozzle 24 according to the image data, and a purge control program that purges the bubbles generated within the jetting module 50. The control program may be obtained using the HDD 228, a reader in which the program is stored in the outer storing medium (not illustrated) and then the outer storing medium is mounted to read out the program or a network (not illustrated) such as, for example, a LAN.

The CPU 216 controls the operations of the jetting module control unit 204, the pressure control unit 206, the drain control unit 208, the pump control unit 212 and the temperature control unit 214 which are connected to the I/O unit 224 based on the read out control program. A nozzle jetting device 51 (for example, a device that discharges ink droplets from the nozzle by the vibration of a pressure chamber through current conduction control of a piezoelectric device) incorporated in the jetting module 50, the supply valve 68, the discharge valve 72, the first flow valve 84, and the second flow valve 86 are connected to the jetting module control unit 204. The opening/closing controls of these valves are performed by the jetting module control unit 204.

The supply air valve 97 and the discharge air valve 174 are connected to the pressure control unit 206, and the opening/closing controls of these valves are performed by the pressure control unit 206. The supply drain valve 154 and the discharge drain valve 184 are connected to the drain control unit 208, and the opening/closing controls of these valves are performed by the drain control unit 208. An ink temperature controller 144 is connected to the temperature control unit 214, and the driving control of the ink temperature controller 144 is performed by the temperature control unit 214.

Further, the supply pump 138, the discharge pump 178 and the supplement pump 196 are connected to the pump control unit 212, the pump control unit 212 is controlled based on the control program read out by the CPU 216, and thus, the driving controls of the supply pump 138, the discharge pump 178, and the supplement pump 196 are performed by the pump control unit 212.

### Driving Controls of Supply Pump 138 and Discharge Pump 178 by Pump Control Unit 212

Next, the driving controls of the supply pump 138 and the discharge pump 178 by the pump control unit 212 will be described in detail.

In the present exemplary embodiment, in the normal operation state (a state where an image forming is formed by the inkjet recording head 20Y based on the image forming instruction according to an image data), the pump control unit 212 controls the driving of the supply pump 138 by a PID control such that the supply pressure becomes a predetermined target pressure value (a negative pressure value in the present exemplary embodiment) based on the supply pressure detected by the supply pressure sensor 88, and controls the driving of the discharge pump 178 by a PID control such that the discharge pressure becomes a predetermined target pressure value (a negative pressure value lower than the supply pressure in the present exemplary embodiment) based on the discharge pressure detected by the discharge pressure sensor 92. At this time, a proportional gain Kp, an integral gain Ki, and a differential gain Kd which are the control parameters of the PID control are set to initial values Kp_{—}0, Ki_{—}0, Kd_{—}0, respectively. The PID control is a kind of a feedback control, and is a known control method in which a control of input value is performed by three (3) elements of a deviation between an output value and a target value, an integral thereof and a differential thereof.

The supply pressure is adjusted such that the supply pressure of the ink within the common supply line 46 becomes a predetermined pressure (a negative pressure in the present exemplary embodiment) by the control of the driving of the supply pump 138 using the pump control unit 212, and the discharge pressure is adjusted such that the discharge pressure of the ink within the common discharge line 54 becomes a pressure lower than the supply pressure (a negative pressure in the present exemplary embodiment) by the control of the driving of the discharge pump 178 using the pump control unit 212. Therefore, a flow of ink (circulation flow) from the common supply line 46 to the individual supply lines 62, the jetting module 50, the individual discharge lines 66, the common discharge line 54, and the buffer tank 132 is generated, and the back pressure in the nozzle surface 22 of the jetting module 50 is maintained to a predetermined pressure (a negative pressure in the present exemplary embodiment).

Meanwhile, strictly, for example, the height positions, the ink flow rates or the flow line resistances of the common supply line 46 (the supply manifold 58) and the common discharge line 54 (the discharge manifold 64) are related as the back pressure elements, and thus, these are considered when a predetermined pressure is set.

The driving control of the supply pump 138 and the discharge pump 178 by the pump control unit 212 are performed as follows. That is, each of the supply pump 138 and the discharge pump 178 calculates the increasing/decreasing amount of the pump speed to determine the final pump speed, based on ΔU(i) as below, and then are driven at the final pump speed.

e(i)=X0−X(i)

U(i)=Kp*e(i)+Ki*Ee(i)*Δt+Kd*(e(i)−e(i−1))/Δt

ΔU(i)=Kp*(e(i)−e(i−1))+Ki*e(i)*Δt+Kd*((e(i)−e(i−1))−((e(i−1)−e(i−2)))/Δt

e(i): Difference of the current pressure value (obtained pressure value) and the target pressure value

X0: Target pressure value

X(i): Obtained pressure value which is obtained by the sensor

Δt: Sampling period

Kp: Proportional gain (control parameter)

Ki: Integral gain (control parameter)

Kd: Differential gain (control parameter)

U(i): Flow rate

ΔU(i): Difference of the flow rates of the previous time and the this time

In the present exemplary embodiment, in a case where a maintenance such as, for example, discharging of the bubbles is performed, the pump control unit 212 changes the control parameters Kp, Ki, Kd from the initial values to control the supply pump 138 when the deviation of the obtained pressure value which is obtained by the supply pressure sensor 88 and the target pressure value exceeds a predetermined reference value, and changes the control parameters Kp, Ki, Kd from the initial values to control the discharge pump 178 when the deviation of the obtained pressure value which is obtained by the discharge pressure sensor 92 and the target pressure value exceeds a predetermined value. Specifically, the control is performed by a control flow (order) as described below.

### First Control Flow

First, a first control flow will be described in which a control parameter Kp (proportional gain) is changed as an adjusting parameter.

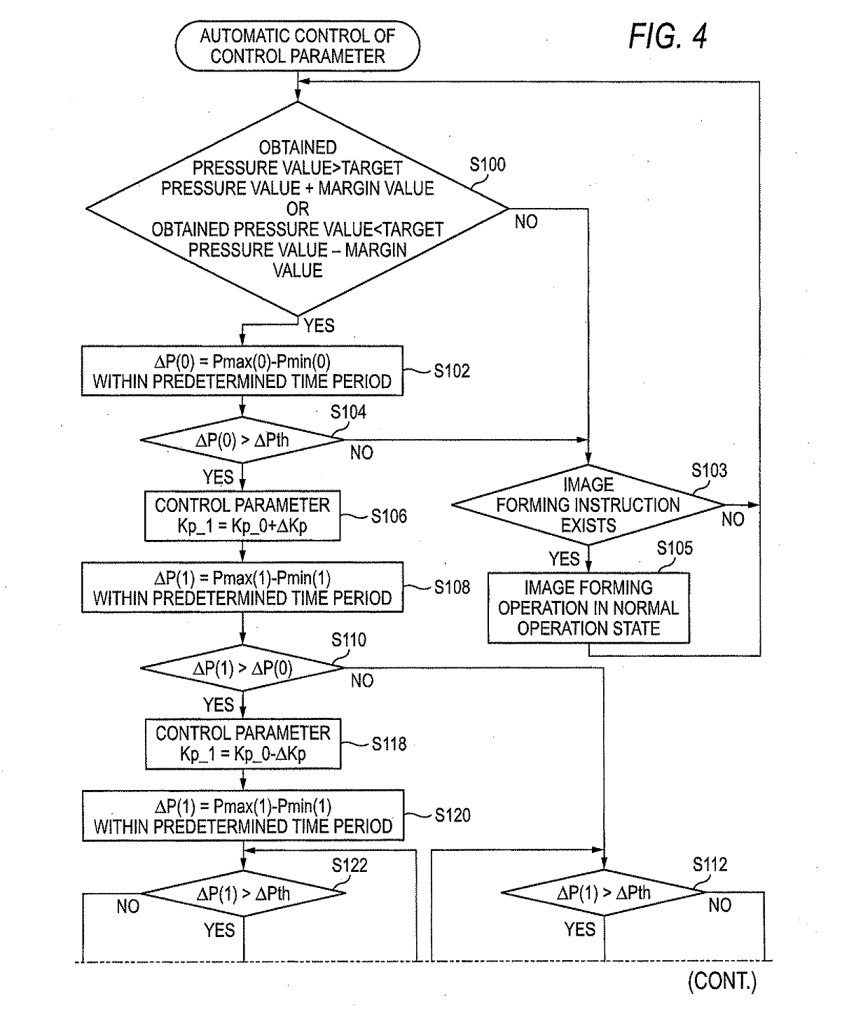

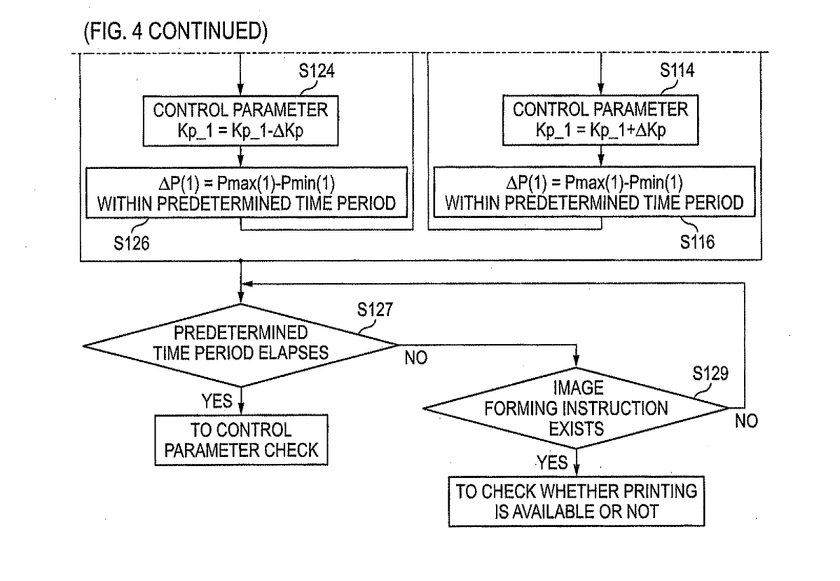

As illustrated in FIG. 4, first, at step S100, whether an obtained pressure value is larger than a value where a predetermined reference value (margin value) is added to the target pressure value is determined (condition 1), and whether the obtained pressure value is smaller than a value where the predetermined reference value (margin value) is subtracted from the target pressure value is determined (condition 2).

When the obtained pressure value satisfies with none of the condition 1 and the condition 2, the process proceeds to step S103 to determine whether or not an image forming instruction exists. When the image forming instruction exists, the process proceeds to step S105, and then performs the image forming operations in the normal state to return to step S100. When the image forming instruction does not exist, the process returns to step S100 not via step S105.

As a result of the determination at step S100, when the obtained pressure value satisfies with any one of the condition 1 and the condition 2, the process proceeds to step S102 to calculate a pressure amplitude ΔP(0)(=Pmax(0)−Pmin(0)) based on the maximum value Pmax(0) and the minimum value Pmin(0) of the obtained pressure within a predetermined time period.

Next, at step S104, whether the pressure amplitude ΔP(0) calculated at step S102 is larger than a predetermined permissible amplitude ΔPth is determined. When the pressure amplitude ΔP(0) is not more than the permissible amplitude ΔPth, the process proceeds to step S103 to determine whether or not the image forming instruction exists. When the image forming instruction exists, the process proceeds to step S105, and then performs the image forming operations in the normal state to return to step S100. When the image forming instruction does not exist, the process returns to step S100 not via step S105.

As a result of the determination at step S104, when the pressure amplitude ΔP(0) is larger than the permissible amplitude ΔPth, the process proceeds to step S106 to change the control parameter from the initial value Kp_{—}0 into Kp_{—}1(=Kp_{—}0+ΔKp).

Next, at step S108, the pressure amplitude ΔP(1)(=Pmax(1)−Pmin(1)) is calculated based on the maximum value Pmax(1) and the minimum value Pmin(1) of the obtained pressure within a predetermined time period. Next, at step S110, whether the pressure amplitude ΔP(1) calculated at step S108 is larger than the pressure amplitude ΔP(0) calculated at step S102 is determined. When the pressure amplitude ΔP(1) is not more than the pressure amplitude ΔP(0), the process proceeds to step S112. As a result of the determination at step S110, when the pressure amplitude ΔP(1) is larger than the pressure amplitude an, the process proceeds to step S118.

At step S112, whether the pressure amplitude ΔP(1) calculated at step S108 is larger than the permissible amplitude ΔPth is determined. When the pressure amplitude ΔP(1) is not more than the permissible amplitude ΔPth, the process proceeds to step S127 to determine whether or not the predetermined time period elapses. When the predetermined time period elapses, a first control parameter check operation, as described below, is performed which confirms that the changed control parameter may return to the initial value. When the predetermined time period does not elapse, the process proceeds to step S129 to determine whether or not the image forming instruction exists. When the image forming instruction exists, an operation for checking whether a first printing is available or not, is performed. When the image forming instruction does not exist, the process returns to step S127.

As a result of the determination at step S112, when the pressure amplitude ΔP(1) is larger than the permissible amplitude ΔPth, the process proceeds to step S114 to change the control parameter from Kp_{—}1 into “Kp_{—}1+ΔKp”.

Next, at step S116, the pressure amplitude ΔP(1)(=Pmax(1)−Pmin(1)) is calculated based on the maximum value Pmax(1) and the minimum value Pmin(1) of the obtained pressure within a predetermined time period, and the process returns to step S112. At step S112, whether the pressure amplitude ΔP(1) calculated at step S116 is larger than the permissible amplitude ΔPth is determined. Until the pressure amplitude ΔP(1) becomes not more than the permissible amplitude ΔPth, steps S114, S116, S112 are repeated. Whenever steps S114, S116, S112 are repeated, ΔKp is added at step S114.

At step S118, the control parameter Kp_{—}1 is changed into “Kp_{—}0−ΔKp”. Next, at step S120, the pressure amplitude ΔP(1)(=Pmax(1)−Pmin(1)) is calculated based on the maximum value Pmax(1) and the minimum value Pmin(1) of the obtained pressure within a predetermined time period.

Next, at step S122, whether the pressure amplitude ΔP(1) calculated at step S120 is larger than the permissible amplitude ΔPth is determined. When the pressure amplitude ΔP(1) is not more than the permissible amplitude ΔPth, the process proceeds to step S127 to determine whether or not a predetermined time period elapses. When the predetermined time period elapses, a first control parameter check operation as described below is performed. When the predetermined time period does not elapse, the process proceeds to step S129 to determine whether or not the image forming instruction exists. When the image forming instruction exists, the operation for checking whether printing is available or not, is performed. When the image forming instruction does not exist, the process returns to step S127.

As a result of the determination at step S122, when the pressure amplitude ΔP(1) is larger than the permissible amplitude ΔPth, the process proceeds to step S124 to change the control parameter from Kp_{—}1 into “Kp_{—}1−ΔKp”.

Next, at step S126, the pressure amplitude ΔP(1)(=Pmax(1)−Pmin(1)) is calculated based on the maximum value Pmax(1) and the minimum value Pmin(1) of the obtained pressure within a predetermined time period, and the process returns to step S122. At step S122, whether the pressure amplitude ΔP(1) calculated at step S126 is larger than the permissible amplitude ΔPth is determined. Until the pressure amplitude ΔP(1) becomes not more than the permissible amplitude ΔPth, steps S124, S126, S122 are repeated. Whenever steps S124, S126, S122 are repeated, ΔKp is subtracted at step S124.

### Second Control Flow

Next, a second control flow will be described in which a control parameter Ki (integral gain) is changed as an adjusting parameter. Meanwhile, the portions which are different from the first control flow will be described.

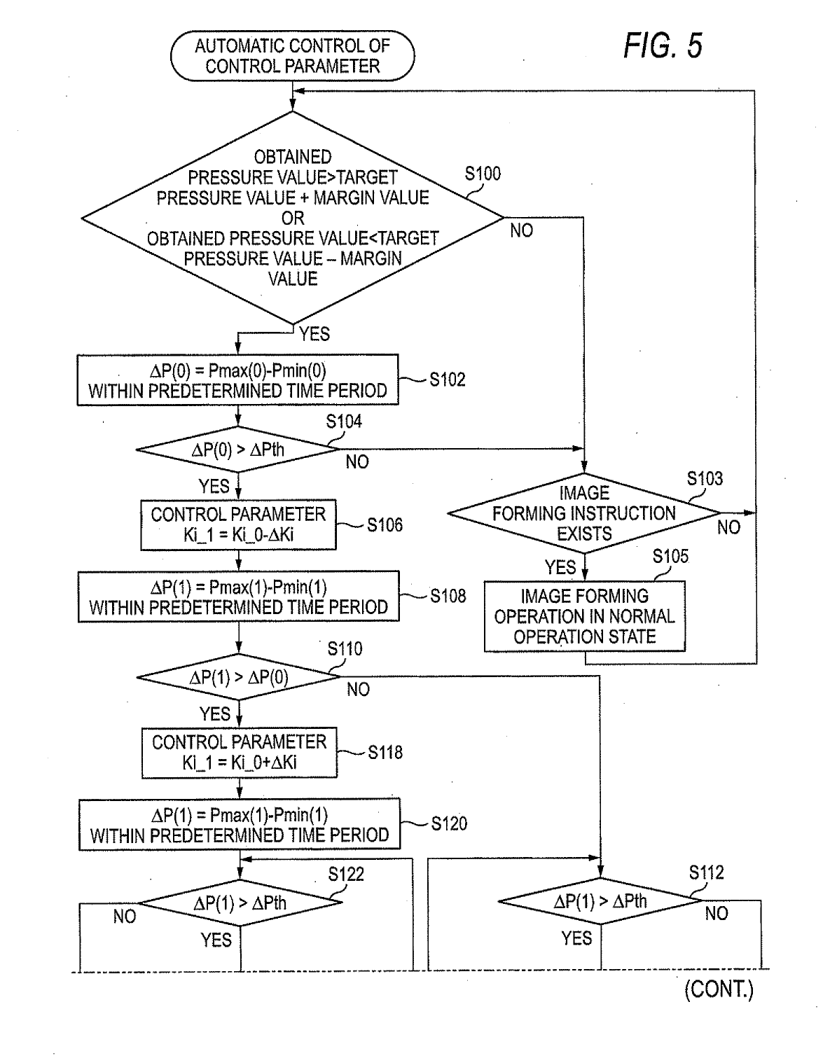

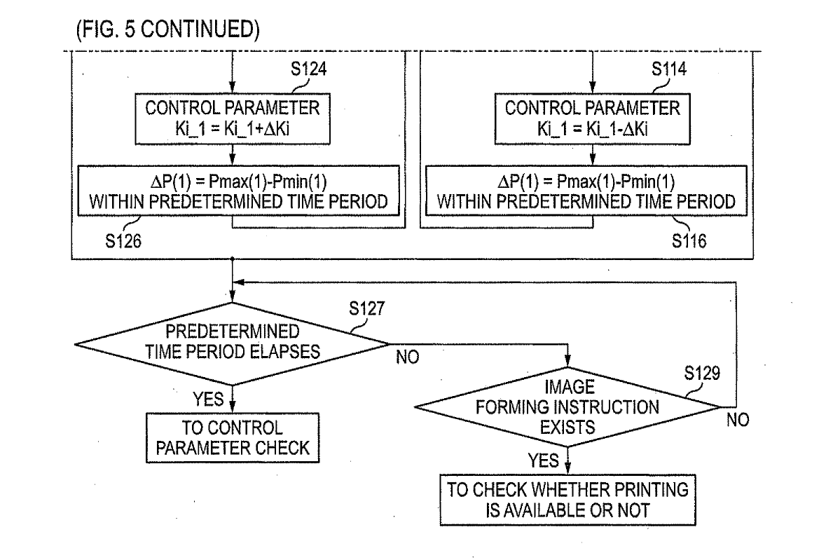

In the second control flow, as illustrated in FIG. 5, the control parameter is changed from an initial value Ki_{—}0 into Ki_{—}1(=Ki_{—}0−ΔKi) at step S106. At step S114, the control parameter Ki_{—}1 is changed into “Ki_{—}1−ΔKi”. At step S118, the control parameter Ki_{—}1 is changed into “Ki_{—}0+ΔKi”. At step S124, the control parameter Ki_{—}1 is changed into “Ki_{—}1+ΔKi”.

The control parameter check operation performed through the second control flow is a second control parameter check operation as described below.

### Third Control Flow

Next, a third control flow will be described. The third control flow is performed in replace of or in addition to the first control flow. In the first control flow, the determination is performed based on the pressure amplitude ΔP calculated from the maximum value Pmax and the minimum value Pmin of the obtained pressure within a predetermined time period, but in the third control flow, a determination is performed based on the accumulation of the deviation (absolute value) from the target pressure value within a predetermined time period. Hereinafter, the flow will be described in detail.

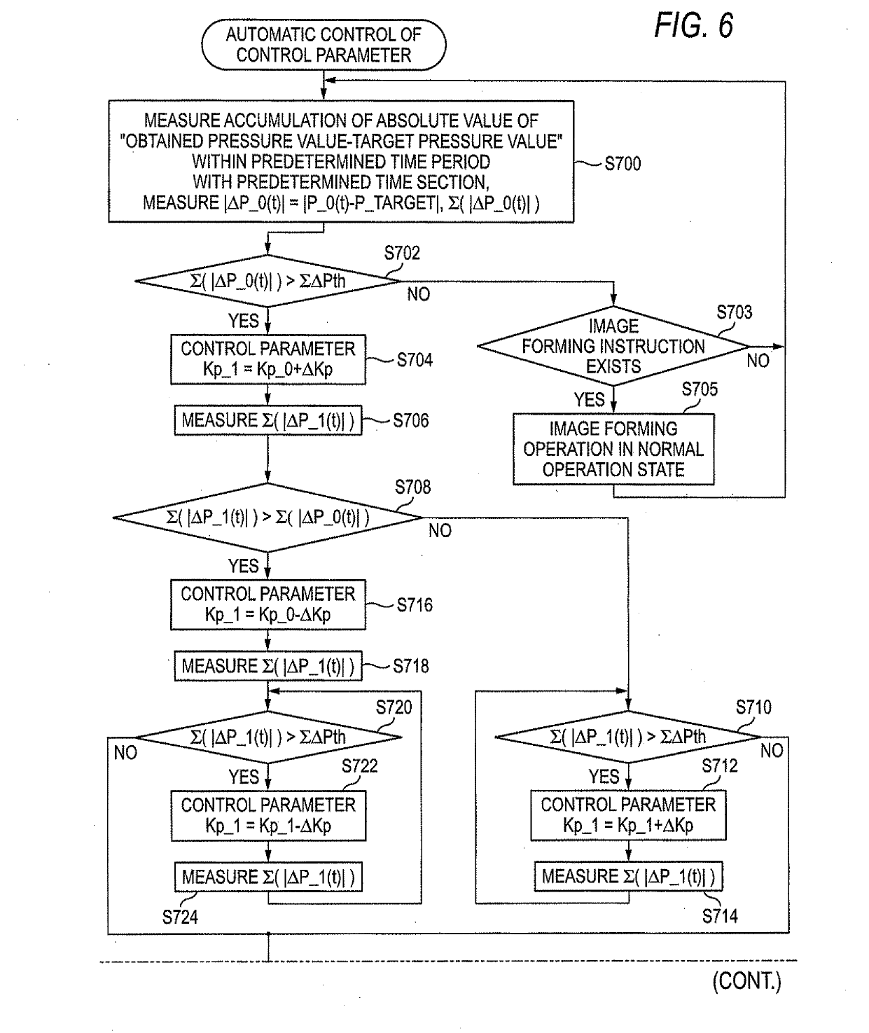

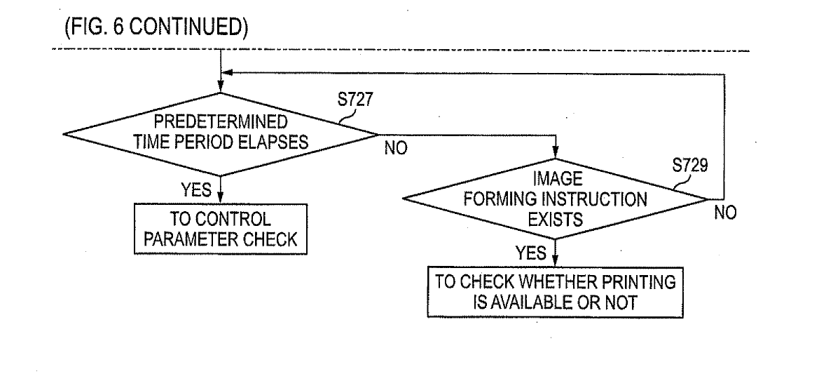

As illustrated in FIG. 6, first, at step S700, an accumulation Σ(|ΔP_{—}0(t)|) of an absolute value |ΔP_{—}0(t)| of “obtained pressure value P_{—}0(t)—target pressure value P_target” within a predetermined time period is measured with a predetermined time section Δt.

Next, at step S702, whether the accumulation Σ(|ΔP_{—}0(t)|) calculated at step S700 is larger than a predetermined permissible accumulation ΣΔPth is determined. When the accumulation Σ(|ΔP_{—}0(t)|) is not more than the permissible accumulation ΣΔPth, the process proceeds to step S703 to determine whether or not the image forming instruction exists. When the image forming instruction exists, the process proceeds to step S705, and then performs the image forming operations to return to step S700. When the image forming instruction does not exist, the process returns to step S700 not via step S705.

As a result of the determination at step S702, when the accumulation Σ(|ΔP_{—}0(t)|) is larger than the permissible accumulation ΣΔPth, the process proceeds to step S704 to change the control parameter from the initial value Kp_{—}0 into Kp_{—}1(=Kp_{—}0+ΔKp).

Next, at step S706, the accumulation Σ(|ΔP_{—}1(t)|) of the absolute value |ΔP_{—}1(t)| of “obtained pressure value P_{—}1(t)—target pressure value P_target” within a predetermined time period is measured with a predetermined time section Δt. Next, at step S708, whether the accumulation Σ(|ΔP_{—}1(t)|) calculated at step S706 is larger than the accumulation Σ(|ΔP_{—}0(t)|) calculated at step S700 is determined. When the accumulation Σ(|ΔP_{—}1(t)|) is not more than the accumulation Σ(|ΔP_{—}0(t)|), the process proceeds to step S710. As a result of the determination at step S708, when the accumulation Σ(|ΔP_{—}1(t)|) is larger than the accumulation Σ(|ΔP_{—}0(t)|), the process proceeds to step S716.

At step S710, whether the accumulation Σ(|ΔP_{—}1(t)|) calculated at step S706 is larger than the permissible accumulation ΣΔPth is determined. When the accumulation Σ(|ΔP_{—}1(t)|) is not more than the permissible accumulation ΣΔPth, the process proceeds to step S727 to determine whether or not the predetermined time period elapses. When the predetermined time period elapses, the first control parameter check operation, as described below, is performed which confirms that the changed control parameter may return to the initial value. When the predetermined time period does not elapse, the process proceeds to step S729 to determine whether or not the image forming instruction exists. When the image forming instruction exists, the operation for checking whether the printing is available or not, is performed. When the image forming instruction does not exist, the process returns to step S727.

As a result of the determination at step S710, when the accumulation Σ(|ΔP_{—}1(t)|) is larger than the permissible accumulation ΣΔPth, the process proceeds to step S712 to change the control parameter from the initial value Kp_{—}1 into “Kp_{—}1+ΔKp”.

Next, at step S714, the accumulation Σ(|ΔP_{—}1(t)|) of the absolute value |ΔP_{—}1(t)| of “obtained pressure value P_{—}1(t)—target pressure value P_target” within a predetermined time period is measured with a predetermined time section Δt to return to step S710. At step S710, whether the accumulation Σ(|ΔP_{—}1(t)|) calculated at step S714 is larger than the permissible accumulation ΣΔPth is determined. Until the accumulation Σ(|ΔP_{—}1(t)|) becomes not more than the permissible accumulation ΣΔPth, steps S712, S714, S710 are repeated. Whenever steps S712, S714, S710 are repeated, ΔKp is added at step S712.

At step S716, the control parameter Kp_{—}1 is changed into “Kp_{—}0−ΔKp”. Next, at step S718, the accumulation Σ(|ΔP_{—}1(t)|) of the absolute value |ΔP_{—}1(t)| of “obtained pressure value P_{—}1(t)—target pressure value P_target” within a predetermined time period is measured with a predetermined time section Δt.

At step S720, whether the accumulation Σ(|ΔP_{—}1(t)|) calculated at step S718 is larger than the permissible accumulation ΣΔPth is determined. When the accumulation Σ(|ΔP_{—}1(t)|) is not more than the permissible accumulation ΣΔPth, the process proceeds to step S727 to determine whether or not a predetermined time period elapses. When the predetermined time period elapses, the first control parameter check operation as described below is performed. When the predetermined time period does not elapse, the process proceeds to step S729 to determine whether or not the image forming instruction exists. When the image forming instruction exists, the operation for checking whether the printing is available or not, is performed. When the image forming instruction does not exist, the process returns to step S727.

As a result of the determination at step S720, when the accumulation Σ(|ΔP_{—}1(t)|) is larger than the permissible accumulation ΣΔPth, the process proceeds to step S722 to change the control parameter Kp_{—}1 into “Kp_{—}1−ΔKp”.

Next, at step S724, the accumulation Σ(|ΔP_{—}1(t)|) of the absolute value |ΔP_{—}1(t)| of “obtained pressure value P_{—}1(t)—target pressure value P_target” within a predetermined time period is measured with a predetermined time section Δt to return to step S720. At step S720, whether the accumulation Σ(|ΔP_{—}1(t|) calculated at step S720 is larger than the permissible accumulation ΣΔPth is determined. Until the accumulation Σ(|ΔP_{—}1(t)|) becomes not more than the permissible accumulation ΣΔPth, steps S722, S724, S720 are repeated. Whenever steps S722, S724, S720 are repeated, ΔKp is subtracted at step S722.

### Fourth Control Flow

Next, a fourth control flow will be described in which the control parameter Ki is used as an adjusting parameter in the third control flow. The fourth control flow is performed in replace of or in addition to the second control flow. Meanwhile, the portions which are different from the third control flow will be described.

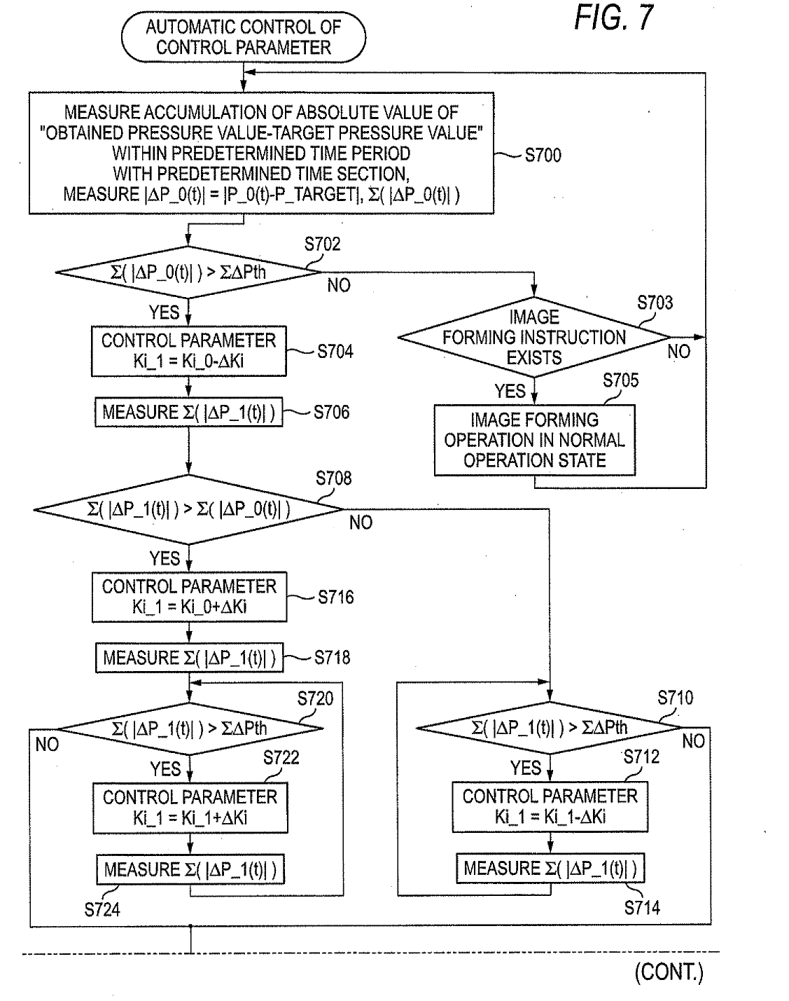

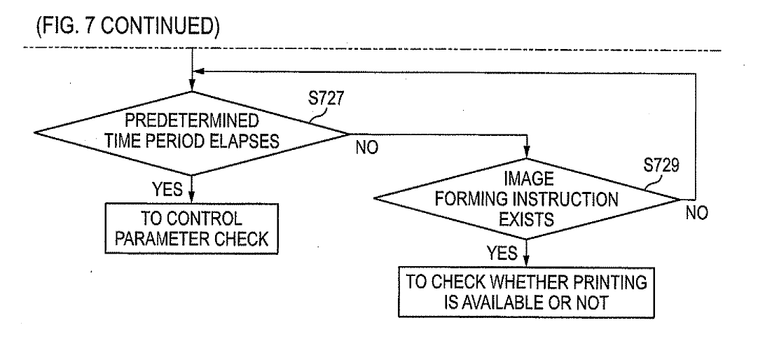

In the fourth control flow, as illustrated in FIG. 7, the control parameter is changed from an initial value Ki_{—}0 into “Ki_{—}1(=Ki_{—}0−ΔKi) at step S704. At step S712, the control parameter Ki_{—}1 is changed into “Ki_{—}1−ΔKi”. At step S716, the control parameter Ki_{—}1 is changed into “Ki_{—}0+ΔKi”. At step S722, the control parameter Ki_{—}1 is changed into “Ki_{—}1+ΔKi”.

The control parameter check operation performed through the fourth control flow is the second control parameter check operation as described below.

### First Control Parameter Check Operation

Next, the first control parameter check operation will be described in which the changed control parameter may be returned to the initial value in the first control flow or the third control flow. The first control parameter check operation is a check operation (confirmation operation) using “Kp” as an adjusting parameter.

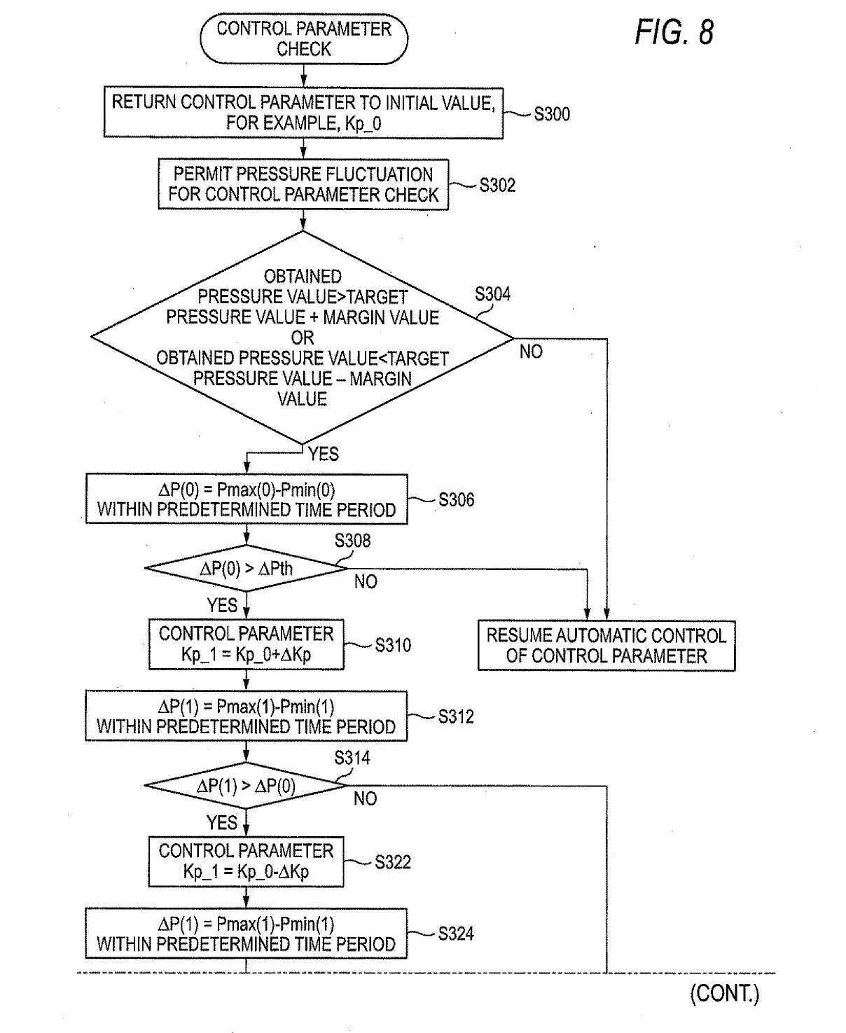

As illustrated in FIG. 8, when the first control parameter check operation is initiated, first, the control parameter is returned to the initial value Kp_{—}0 at step S300. Next, at step S302, a predetermined amount of ink is discharged with respect to the flow line (supply line and discharge line), and thus, a pressure fluctuation for the control parameter check operation is temporarily generated.

Next, at step S304, whether an obtained pressure value is larger than a value where a predetermined reference value (margin value) is added to the target pressure value is determined (condition 1), and whether the obtained pressure value is smaller than a value where the predetermined reference value (margin value) is subtracted from the target pressure value is determined (condition 2).

When the obtained pressure value satisfies with none of the condition 1 and the condition 2, an automatic control of the control parameter (the first control flow) is resumed. When the obtained pressure value satisfies with any one of the condition 1 and the condition 2, the process proceeds to step S306 to calculate a pressure amplitude ΔP(0)(=Pmax(0)−Pmin(0)) based on the maximum value Pmax(0) and the minimum value Pmin(0) of the obtained pressure within a predetermined time period.

Next, at step S308, whether the pressure amplitude ΔP(0) calculated at step S306 is larger than a predetermined permissible amplitude ΔPth is determined. When the pressure amplitude ΔP(0) is not more than the permissible amplitude ΔPth, the automatic control of the control parameter (the first control flow) is resumed. When the pressure amplitude ΔP(0) is larger than the permissible amplitude ΔPth, the process proceeds to step S310 to change the control parameter from the initial value Kp_{—}0 into “Kp_{—}1(=Kp_{—}0+ΔKp)”.

Next, at step S312, the pressure amplitude ΔP(1)(=Pmax(1)−Pmin(1)) is calculated based on the maximum value Pmax(1) and the minimum value Pmin(1) of the obtained pressure within a predetermined time period. Next, at step S314, whether the pressure amplitude ΔP(1) calculated at step S312 is larger than the pressure amplitude ΔP(0) calculated at step S306 is determined. When the pressure amplitude ΔP(1) is not more than the pressure amplitude ΔP(0), the process proceeds to step S316. As a result of the determination at step S314, when the pressure amplitude ΔP(1) is larger than the pressure amplitude ΔP(0), the process proceeds to step S322.

At step S316, whether the pressure amplitude ΔP(1) calculated at step S312 is larger than the permissible amplitude ΔPth is determined. When the pressure amplitude ΔP(1) is not more than the permissible amplitude ΔPth, the first control parameter check operation is resumed after a predetermined time period elapses. When the pressure amplitude ΔP(1) is larger than the permissible amplitude ΔPth, the process proceeds to step S318 to change the control parameter Kp_{—}1 into “Kp_{—}1+ΔKp”.

Next, at step S320, the pressure amplitude ΔP(1)(=Pmax(1)−Pmin(1)) is calculated based on the maximum value Pmax(1) and the minimum value Pmin(1) of the obtained pressure within a predetermined time period, and the process returns to step S316. At step S316, whether the pressure amplitude ΔP(1) calculated at step S320 is larger than the permissible amplitude ΔPth is determined. Until the pressure amplitude ΔP(1) becomes not more than the permissible amplitude ΔPth, steps S318, S320, S316 are repeated. Whenever steps S318, S320, S316 are repeated, ΔKp is added at step S318.

At step S322, the control parameter Kp_{—}1 is changed into “Kp_{—}0−ΔKp”. Next, at step S324, the pressure amplitude ΔP(1)(=Pmax(1)−Pmin(1)) is calculated based on the maximum value Pmax(1) and the minimum value Pmin(1) of the obtained pressure within a predetermined time period.

Next, at step S326, whether the pressure amplitude ΔP(1) calculated at step S324 is larger than the permissible amplitude ΔPth is determined. When the pressure amplitude ΔP(1) is not more than the permissible amplitude ΔPth, the first control parameter check operation is resumed after a predetermined time period elapses. When the pressure amplitude ΔP(1) is larger than the permissible amplitude ΔPth, the process proceeds to step S328 to change the control parameter Kp_{—}1 into “Kp_{—}1−ΔKp”.

Next, at step S330, the pressure amplitude ΔP(1)(=Pmax(1)−Pmin(1)) is calculated based on the maximum value Pmax(1) and the minimum value Pmin(1) of the obtained pressure within a predetermined time period, and the process returns to step S326. At step S326, whether the pressure amplitude ΔP(1) calculated at step S330 is larger than the permissible amplitude ΔPth is determined. Until the pressure amplitude ΔP(1) becomes not more than the permissible amplitude ΔPth, steps S328, S330, S326 are repeated. Whenever steps S328, S330, S326 are repeated, ΔKp is subtracted at step S328.

### Second Control Parameter Check Operation

Next, the second control parameter check operation will be described in which the changed control parameter may be returned to the initial value in the second control flow or the fourth control flow. The second control parameter check operation is a check operation (confirmation operation) using “Ki” as an adjusting parameter. Meanwhile, the portions which are different from the first control parameter check operation will be described.

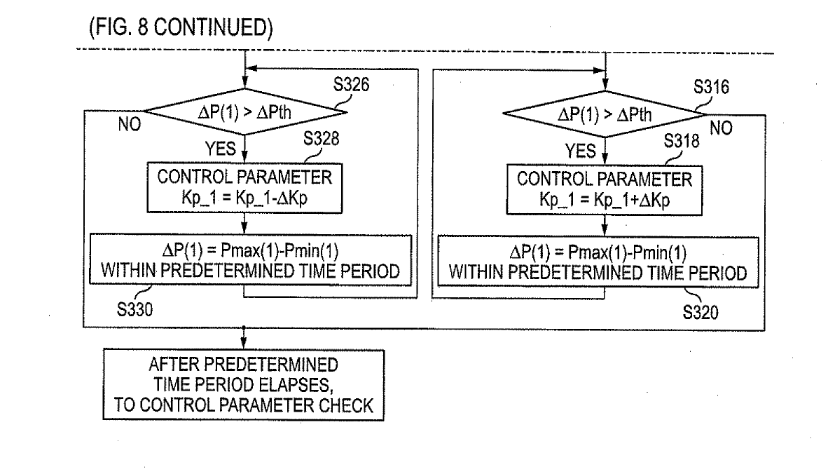

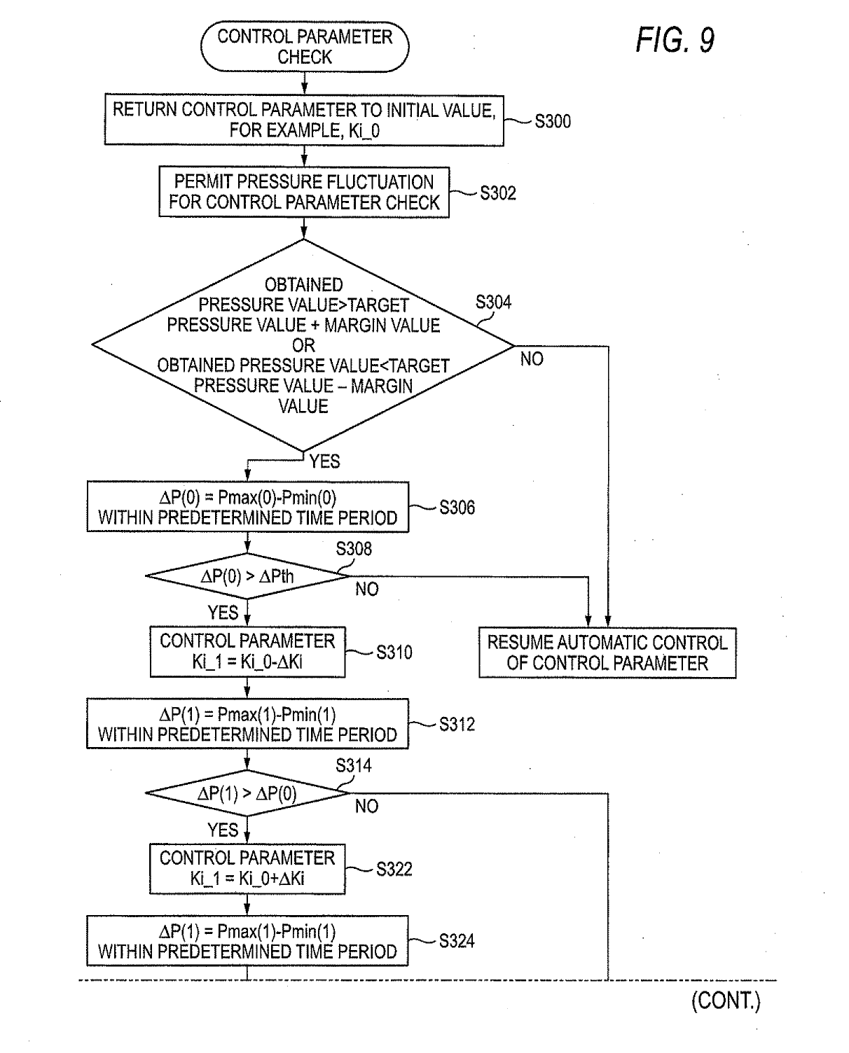

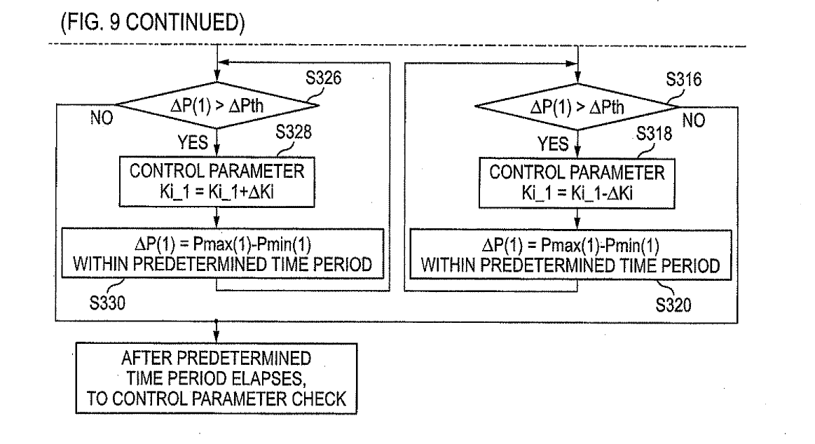

In the second control parameter check operation, as illustrated in FIG. 9, the control parameter is changed from an initial value Ki_{—}0 into Ki_{—}0(=Ki_{—}0−ΔKi) at step S310. At step S318, the control parameter Ki_{—}1 is changed into “Ki_{—}1−ΔKi”. At step S322, the control parameter Ki_{—}1 is changed into “Ki_{—}0−ΔKi”. At step S328, the control parameter Ki_{—}1 is changed into “Ki_{—}1+ΔKi”.

The automatic control of the control parameter which is resumed through the second control parameter check operation is according to the second control flow. The control parameter check operation which is resumed in the second control parameter check operation is the second control parameter check operation.

### Operation for Checking Whether First Printing (Image Forming) is Available or not

Next, an operation for checking whether a first printing (image forming) is available or not will be described.

In the control parameter check operations as described above, the changed control parameter is returned to the initial value after confirming whether the changed control parameter may be returned, but the operation for checking whether the printing is available or not is a check operation (confirmation operation) in which a printing can be from the initial value to the changed control parameter without being returned to the initial value. Meanwhile, the operation for checking whether the first printing is available or not, is a check operation using “Kp” as an adjusting parameter.

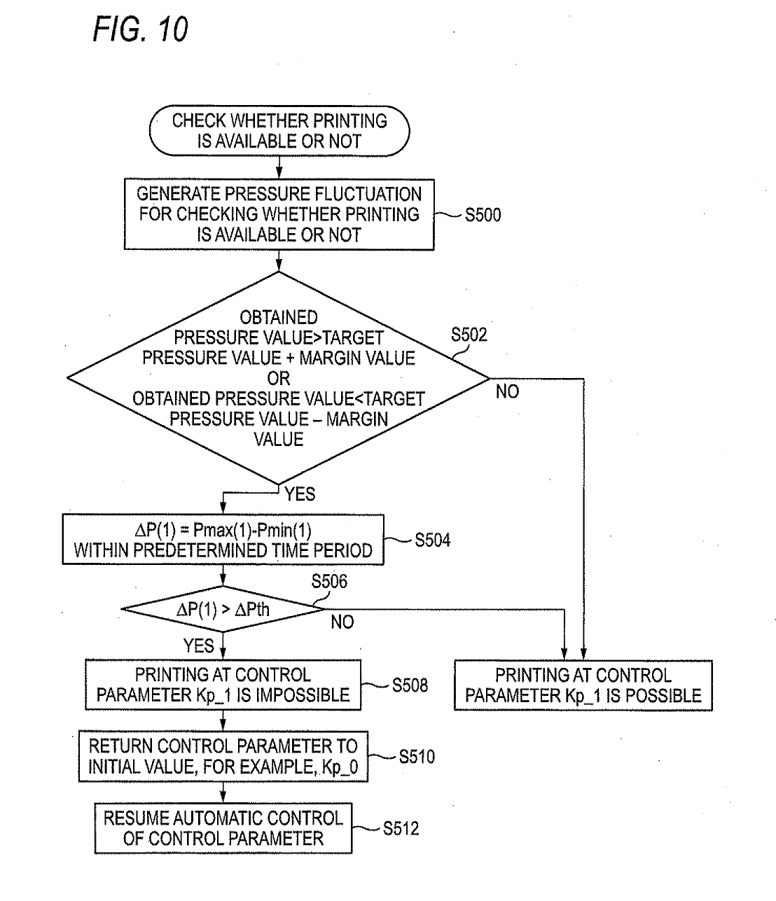

As illustrated in FIG. 10, when the operation for checking whether the printing is available or not is initiated, first, at step S500, a predetermined amount of ink is discharged with respect to the flow line (supply line and discharge line), and thus, a pressure fluctuation for the operation for checking whether the printing is available or not is temporarily generated.

Next, at step S502, whether an obtained pressure value is larger than a value where a predetermined reference value (margin value) is added to the target pressure value is determined (condition 1), and whether the obtained pressure value is smaller than a value the predetermined reference value (margin value) is subtracted from the target pressure value is determined (condition 2).

When obtained pressure value satisfies with none of the condition 1 and the condition 2, the printing at the control parameter Kp_{—}1 is permitted. When the obtained pressure value satisfies with any one of the condition 1 and the condition 2, the process proceeds to step S504 to calculate a pressure amplitude ΔP(1)(=Pmax(1)−Pmin(1)) based on the maximum value Pmax(1) and the minimum value Pmin(1) of the obtained pressure within a predetermined time period.

Next, at step S506, whether the pressure amplitude ΔP(1) calculated at step S504 is larger than a predetermined permissible amplitude ΔPth is determined. When the pressure amplitude ΔP(1) is not more than the permissible amplitude ΔPth, the printing at the control parameter Kp_{—}1 is permitted. When the pressure amplitude ΔP(1) is larger than the permissible amplitude ΔPth, the process proceeds to step S508 and the printing at the control parameter Kp_{—}1 is not permitted. Next, at step S510, the control parameter Kp_{—}1 is returned to the initial value Kp_{—}0, and the automatic control of the control parameter (the first control flow) is resumed.

### Operation for Checking Whether Second Printing (Image Forming) is Available or not

Next, an operation for checking whether a second printing (image forming) is available or not will be described. The operation for checking whether the second printing is available or not is a check operation using “Ki” as an adjusting parameter. Meanwhile, the portions which are different from the operation for checking whether the first printing is available or not, will be described.

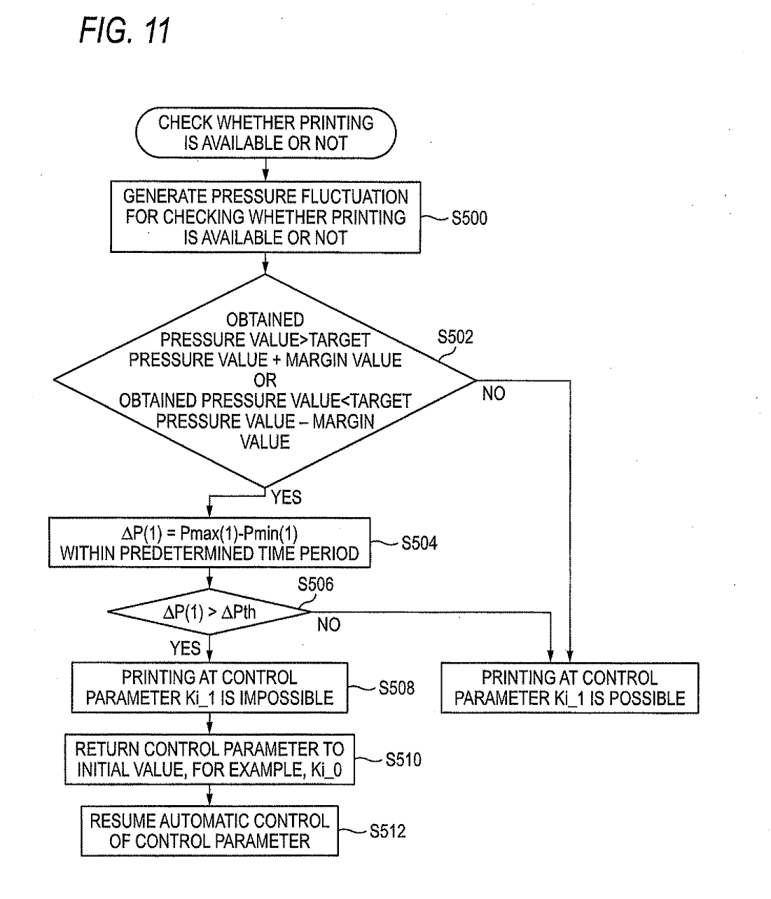

In the operation for checking whether the second printing is available or not, as illustrated in FIG. 11, at step S502, when it is determined that the obtained pressure value satisfies with none of the condition 1 and the condition 2, the printing at the control parameter Ki_{—}1 is permitted. At step S506, when it is determined that the pressure amplitude ΔP(1) is not more than the permissible amplitude ΔPth, the printing at the control parameter Ki_{—}1 is permitted. At step S508, the printing at the control parameter Ki_{—}1 is not permitted. Further, at step S510, the control parameter is returned to the initial value Ki_{—}0, and the automatic control of the control parameter (the second control flow) is resumed.

### Generating Method of Pressure Fluctuation

The specific examples of the generating methods of the pressure fluctuation in the control parameter check operation (see, e.g., step S302) and the pressure fluctuation in the operation for checking whether the printing is available or not (see, e.g., step S500) will be described.

The generating method of the pressure fluctuation includes a method in which a predetermined amount of ink is discharged from the inkjet recording head 20Y (a plurality of jetting modules 50). Specifically, for example, twenty hundreds (2000) shots of droplets may be discharged from the entire nozzles of the inkjet recording head 20Y (a plurality of jetting modules 50). At this time, the inkjet recording head 20Y (a plurality of jetting modules 50) serves as an example of the pressure fluctuating unit that fluctuates the supply pressure and the discharge pressure so that the deviations thereof with the target pressure vale exceed a predetermined reference value.

Further, as a generating method of the pressure fluctuation, a method may be used in which a circulation pump (the supply pump 138 and the discharge pump 178) is stopped in a predetermined time period. Specifically, for example, the supply pump 138 is stopped by 0.5 sec. Therefore, a minus pressure is generated in the flow line. Further, the discharge pump 178 may be stopped by 0.5 sec. Therefore, a plus pressure is generated in the flow line.

Further, as a generating method of the pressure fluctuation, the circulation pump (the supply pump 138 and the discharge pump 178) is rapidly driven in a predetermined time period. Specifically, for example, the supply pump 138 is driven with a maximum speed (for example, 2,000 pps) by 0.5 sec. Therefore, a plus pressure is generated in the flow line. Further, the discharge pump 178 may be driven with a maximum speed (for example, 2,000 pps) by 0.5 sec. Therefore, a minus pressure is generated in the flow line.

As described above, in the configuration in which the supply pressure and the discharge pressure are fluctuated using the circulation pump, the circulation pump may serve as an example of a pressure fluctuating unit that fluctuates the supply pressure and the discharge pressure so that the deviations thereof with the target pressure value exceed a predetermined reference value.

Further, as a generating method of the pressure fluctuation, a method may be used in which an inkjet recording head 20Y moves upwardly and downwardly. Therefore, the pressure fluctuation by the inertia of the ink at time of initiating and stopping of the upward and downward moving operation is generated.

Further, as a generating method of the pressure fluctuation, a method may be used in which an inkjet recording head 20Y moves horizontally. Therefore, the pressure fluctuation by the inertia of the ink at time of initiating and stopping of the horizontal moving operation is generated.

Meanwhile, as a moving mechanism which moves the inkjet recording head 20Y upwardly and downwardly, or horizontally, a moving mechanism is used which moves the inkjet recording head 20Y to perform a maintenance for the inkjet recording head 20Y. At this time, the moving mechanism serves as an example of the pressure fluctuating unit that fluctuates the supply pressure and the discharge pressure so that the deviations thereof with the target pressure value exceed a predetermined reference value.

Meanwhile, the operation that generates a pressure fluctuation by the pressure fluctuating unit, as described above, is not performed continuously, but is performed temporarily. Therefore, the operation that generates a pressure fluctuation by the pressure fluctuating unit does not include a case where a state in which the pressure is fluctuated is maintained (for example, the circulation pump is stopped continuously).

### Effects of the Present Exemplary Embodiments

Next, the effects of the present exemplary embodiments will be described.

First, the effects for a case where the supply pump 138 and the discharge pump 178 are controlled by the first control flow will be described.

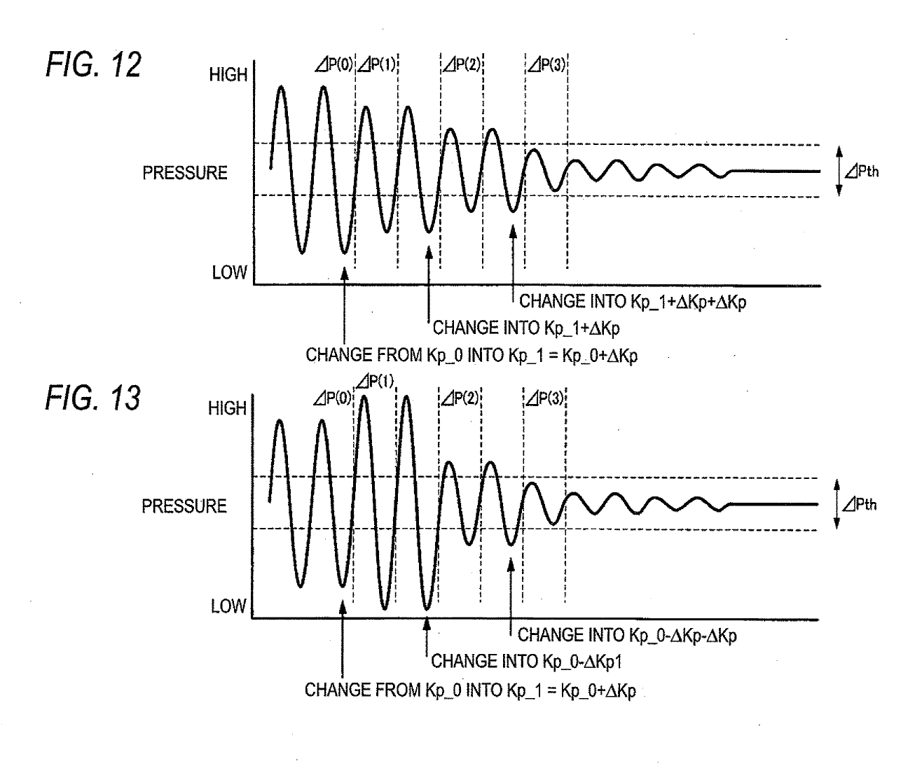

In an example as illustrated in FIG. 12, the supply pump 138 and the discharge pump 178 are controlled using the first control flow. Therefore, the pressure amplitude ΔP(0) which has exceed the permissible amplitude ΔPth in a state before the control becomes decreased when the control parameter is changed from the initial value Kp_{—}0 into Kp_{—}1(=Kp_{—}0+ΔKp) (step S106) and whenever the control parameter Kp_{—}1 is added by ΔKp (step S114). In the example illustrated in FIG. 12, at a timing where the initial value Kp_{—}0 is added by ΔKp three times, the pressure amplitude ΔP(3) becomes within the permissible amplitude ΔPth.

In an example as illustrated in FIG. 13, with respect to the pressure amplitude ΔP(0) which has exceed the permissible amplitude ΔPth in a state before the control, the pressure amplitude ΔP(1) becomes larger than the pressure amplitude ΔP(0) when the control parameter is changed from the initial value Kp_{—}0 into Kp_{—}1(=Kp_{—}0+ΔKp) (step S106).

Therefore, the control parameter Kp_{—}1 is changed into a control parameter where ΔKp is subtracted from the initial value Kp_{—}0 (step S118). Further, until the pressure amplitude ΔP is within the permissible amplitude ΔPth, ΔKp is subtracted from the control parameter (step S124). At a timing where the initial value Kp_{—}0 is subtracted by ΔKp two times, the pressure amplitude ΔP(3) becomes within the permissible amplitude ΔPth.

As described above, when the amplitude ΔP of the pressure (the supply pressure and the discharge pressure) exceeds the permissible amplitude ΔPth, even though, many bubbles exist in the circulation line and the pressure is deviated greatly from the target pressure value such as, for example, at a right after the initial filling of ink, the deviation may be suppressed to be small. In particular, when each of the supply pump 138 and the discharge pump 178 is controlled while the control parameter is not changed from the initial value, the pressure amplitude ΔP(0) which has exceed the permissible amplitude ΔPth is maintained. In the present exemplary embodiments, the pumps are controlled while the control parameter is changed from the initial value, and thus the deviation may be suppressed to be small in a short time period, as compared to a case where the pump is controlled while the control parameter is not changed from the initial value. Meanwhile, even in cases where each of the second control flow, the third control flow and the fourth control flow are used, the same effects may be generated and the same results may be obtained.

Next, an effect in the first control parameter check operation will be described.

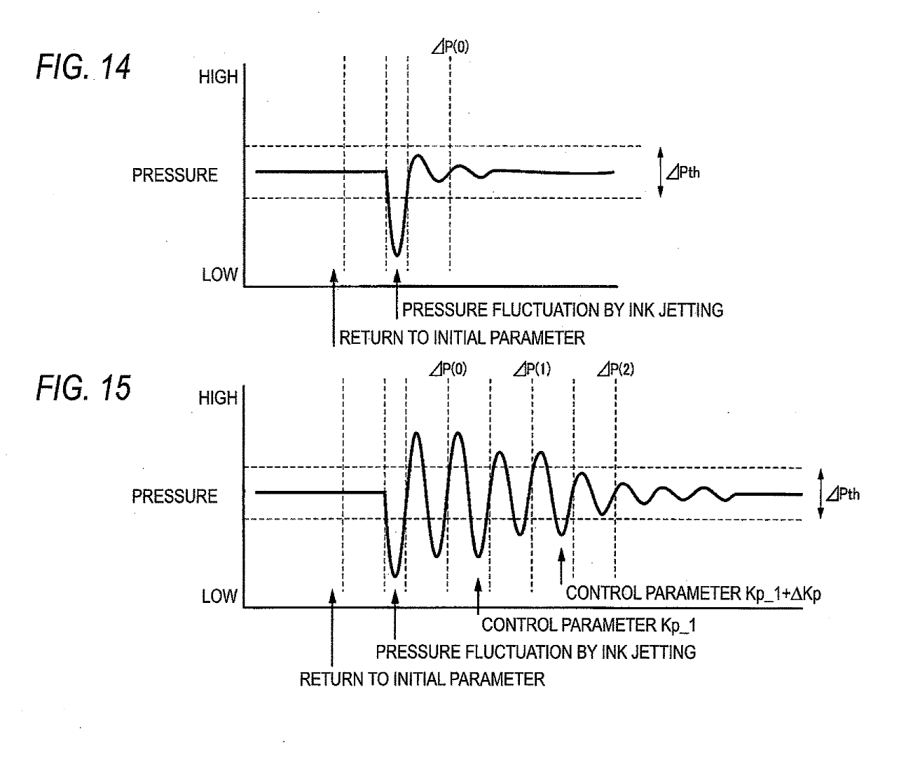

As illustrated in FIG. 14, first, the control parameter is returned to the initial value Kp_{—}0 (step S300). Then, for example, a predetermined amount of ink is discharged, and thus, the pressure fluctuation for the control parameter check operation is generated (step S302). When the pressure amplitude ΔP is within the permissible amplitude ΔPth after the pressure fluctuation for the control parameter check operation, it is determined that the supply pressure and the discharge pressure may be stably controlled even though the control parameter is returned to the initial value Kp_{—}0, therefore, in the state where the control parameter is returned to the initial value Kp_{—}0, the automatic control of the control parameter (the first control flow) is resumed (steps S304 and S308).

Meanwhile, as illustrated in FIG. 15, when a predetermined amount of ink is discharged to generate the pressure fluctuation for the control parameter check operation (step S302), and then, when the pressure amplitude ΔP exceeds the permissible amplitude ΔPth, the control parameter is changed from the initial value Kp_{—}0 into Kp_{—}1(=Kp_{—}0+ΔKp) (step S310), and until the pressure amplitude ΔP is within the permissible amplitude ΔPth, the control parameter Kp_{—}1 is added by ΔKp (step S318).

As described above, the pressure fluctuation for the control parameter check operation is generated, and then it is confirmed that the pressure amplitude ΔP is within the permissible amplitude ΔPth to determine whether the control parameter may be returned to the initial value. As a result, whether or not the control parameter may be returned to the initial value, that is, whether or not the supply pressure and the discharge pressure may be stably controlled even though the control parameter is returned to the initial value, may be determined favorably. Meanwhile, even in the second parameter check operation, the same effects may be generated and the same results may be obtained.

Next, the effects in the operation for checking whether the first printing (image forming) is available or not will be described.

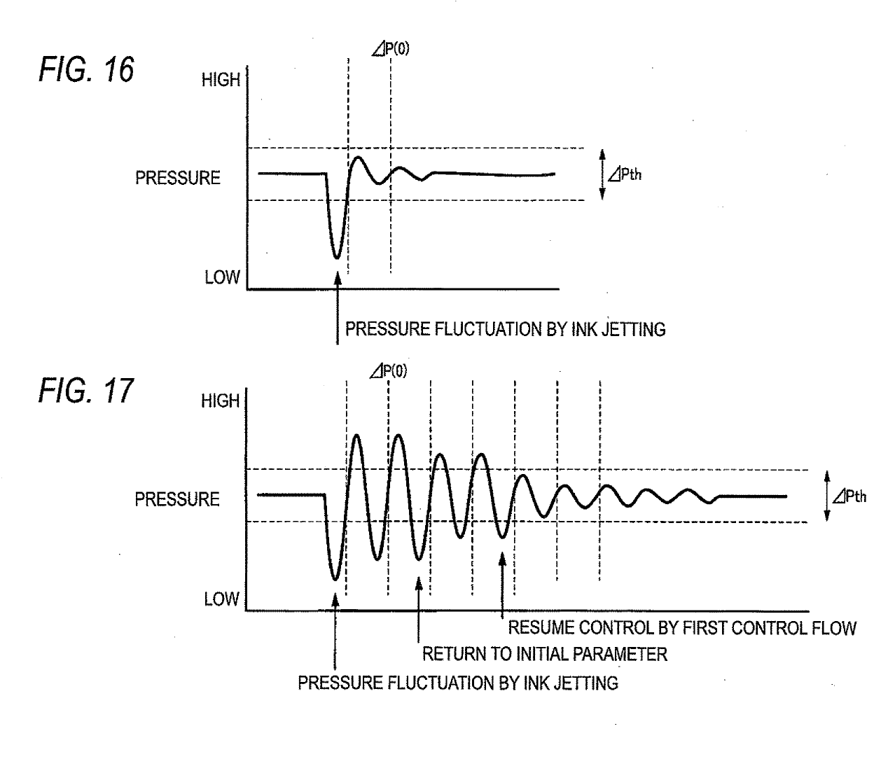

As illustrated in FIG. 16, first, for example, a predetermined amount of ink is discharged, and thus, the pressure fluctuation for the operation for checking whether the printing is available or not is generated (step S500). In a state where the pressure amplitude ΔP is within the permissible amplitude ΔPth after the pressure for the operation for checking whether the printing is available or not is generated, the printing is determined to be stably performed when the control parameter is Kp_{—}1, and the printing at the parameter Kp_{—}1 is permitted (see, e.g., steps S502 and S506).

Meanwhile, as illustrated in FIG. 17, after, for example, a predetermined amount of ink is discharged to generate the pressure fluctuation for operation for checking whether the printing is available or not (step S500), when the pressure amplitude ΔP exceeds the permissible amplitude ΔPth, the control parameter is returned to the initial value Kp_{—}0 and the automatic control of the control parameter (the first control flow) is resumed. The pressure amplitude ΔP is within the permissible amplitude ΔPth by the performing of the control by the first control flow.

As described above, in the operation for checking whether the first printing is available or not, the pressure fluctuation for the operation for checking whether the printing is available or not is generated, and then it is confirmed that the pressure amplitude ΔP is within the permissible amplitude ΔPth to determine whether a liquid may be permitted to be discharged in a state where the control parameter is changed. As a result, the determination may be favorably performed as compared to a case where the pressure fluctuation for the operation for checking whether the printing is available or not is not generated.

In the operation for checking whether the first printing is available or not, in a state where the control parameter is changed from the initial value by the automatic control of the control parameter, whether the liquid is discharged is determined while the control parameter is not returned to the initial value to permit the discharging of the liquid. As a result, the process time may be shorten as compared to a case whether the liquid is discharged is determined after the control parameter is returned to the initial value to permit the discharging of the liquid. Therefore, the control parameter check operation is not performed in which the control may be returned to the initial value after the printing instruction (image forming instruction) is received, but the operation for checking whether the printing is available or not, which determines whether the discharging of the liquid is permitted is performed in a state where the control parameter is changed from the initial value. As a result, the printing (image forming) may be quickly initiated. Even in the operation for checking whether the second printing (image forming) is available or not, the same effects may be generated and the same results may be obtained as in the operation for checking whether the first printing (image forming) is available or not.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

For example, the modifications and variations as described above may be configured by combining the plurality of them properly.

What is claimed is:

1. A liquid supplying mechanism comprising:
a storage unit that stores a liquid;
a supply line that supply a liquid from the storage unit to a jetting unit that discharges the liquid from a nozzle surface thereof;
a discharge line that discharges the liquid from the jetting unit to the storage unit;
a first detecting unit that detects a supply pressure of the liquid within the supply line;
a second detecting unit that detects a discharge pressure of the liquid within the discharge line;
a first pressure adjusting unit that adjusts the supply pressure of the liquid within the supply line;
a second pressure adjusting unit that adjusts the discharge pressure of the liquid within the discharge line; and
a control unit that controls the first pressure adjusting unit and the second pressure adjusting unit by control parameters each having a given initial value on the basis of the supply pressure detected by the first detecting unit and the discharge pressure detected by the second detecting unit, respectively, so that the supply pressure is higher than the discharge pressure while a back pressure at the nozzle surface is maintained at a given value, and when deviations of the detected supply pressure and the detected discharge pressure with respect to the corresponding target pressure value exceed a given reference value, controls each of the first pressure adjusting unit and the second pressure adjusting unit by changing the control parameters from the initial values.

2. The liquid supplying mechanism according to claim 1, further comprising:
a pressure fluctuation unit that fluctuates the supply pressure and the discharge pressure so that the deviations of both of the pressures with respect to the target pressure value exceed the given reference value,
wherein the control unit changes the control parameters to control each of the first pressure adjusting unit and the second pressure adjusting unit, temporarily fluctuates the supply pressure and the discharge pressure by the pressure fluctuation unit, and then determines the deviations of the detected supply pressure and the detected discharge pressure with respect to the corresponding target pressure value, respectively.

3. The liquid supplying mechanism according to claim 2, wherein
the control unit changes the control parameters to control each of the first pressure adjusting unit and the second pressure adjusting unit, temporarily fluctuates the supply pressure and the discharge pressure by the pressure fluctuation unit, and then determines the deviations of the detected supply pressure and the detected discharge pressure with respect to the corresponding target pressure value, respectively, and when the deviations of the supply pressure and the discharge pressure are within the given reference value, the control unit controls each of the first pressure adjusting unit and the second pressure adjusting unit using the initial values.

4. The liquid supplying mechanism according to claim 2, wherein
the control unit changes the control parameters to control each of the first pressure adjusting unit and the second pressure adjusting unit, when the control unit receives an instruction to discharge the liquid from the jetting unit based on an image data without returning the control parameters to the initial values, the control unit temporarily fluctuates the supply pressure and the discharge pressure by the pressure fluctuation unit, and then determines the deviations of the detected supply pressure and the detected discharge pressure with respect to the corresponding target pressure value, respectively, and when the deviations of the supply pressure and the discharge pressure are within the given reference value, the control unit admits the discharge of the liquid by the jetting unit.

5. The liquid supplying mechanism according to claim 1, wherein
the first pressure adjusting unit and the second pressure adjusting unit are pumps.

6. A non-transitory computer readable medium storing a program causing a computer to execute as the control unit of the liquid supplying mechanism according to claim 1.

7. An image forming apparatus comprising:
a liquid supplying apparatus according to claim 1; and
a discharging unit configured to discharge the liquid supplied by the liquid supplying apparatus onto a recording medium to form an image.
